(19) United States
(12) Patent Application Publication
(10) Pub. No.: US 2025/0056336 A1
(43) Pub. Date: Feb. 13, 2025

(54) METHOD AND APPARATUS FOR TRANSFERRING OR DELIVERING AI MODELS DURING HANDOVER IN WIRELESS COMMUNICATION SYSTEMS

(71) Applicant: Samsung Electronics Co., Ltd., Suwon-si (KR)

(72) Inventors: Jungsuk BAIK, Suwon-si (KR); Sooeun SONG, Suwon-si (KR); Suhwook KIM, Suwon-si (KR); Changsung LEE, Suwon-si (KR)

(21) Appl. No.: 18/800,614

(22) Filed: Aug. 12, 2024

(30) Foreign Application Priority Data
Aug. 11, 2023 (KR) 10-2023-0105738

(51) Int. Cl. H04W 36/00; H04W 24/02; H04W 72/1268

(52) U.S. Cl. CPC H04W 36/0058; H04W 24/02; H04W 72/1268

(57) ABSTRACT

The disclosure relates to a 5G or 6G communication system for supporting higher data transfer rates. A method performed by a first base station in a communication system is provided. The method includes receiving a measurement report from a terminal, transferring, to a second base station, a handover request message including information for transferring an artificial intelligence (AI) model, determining a first AI model for transferring the AI model of the terminal based on a response message for a handover request and AI information of the terminal previously received from the terminal, the handover request including response information to the information for transferring the AI model received from the second base station, and transferring, to the terminal, the determined first AI model and a message for performing handover.

### CROSS-REFERENCE TO RELATED APPLICATION(S)

This application is based on and claims priority under 35 U.S.C. § 119 (a) of a Korean patent application number 10-2023-0105738, filed on Aug. 11, 2023, in the Korean Intellectual Property Office, the disclosure of which is incorporated by reference herein in its entirety.

### BACKGROUND

### 1. Field

The disclosure relates to a method for transferring or delivering an artificial intelligence (AI) model in a wireless communication system. More particularly, the disclosure relates to a method and apparatus for transferring or delivering an AI model during handover in a wireless communication system.

### 2. Description of Related Art

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

As mentioned above, more AI-based communication technology models will be developed and developed in the 6G communication system, and accordingly, there is a need to discuss specific procedures for determining and using the AI model between a UE and a base station.

Meanwhile, existing communication systems do not define information or operations to determine AI model transferring between the UE and the base station and to determine detailed options. In the case of transferring or delivering the AI model during the handover process, in case that the UE is located at the edge of a cell operated by the base station and the UE cannot reliably receive signals transferred from the base station, as the transfer or delivery of the model fails, or the number of AI models to be transferred or size of the AI model increases, the probability of AI model transfer failure may increase. Therefore, operations are needed to control the possibility and minimize transfer failure of the AI model.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide various methods and apparatuses for efficiently transferring or delivering an AI model in a mobile communication system.

Additional aspects will be set forth in part in the description which follows and, in part, will be apparent from the description, or may be learned by practice of the presented embodiments.

In accordance with an aspect of the disclosure, a method performed by a first base station in a communication system is provided. The method includes receiving a measurement report from a terminal, transferring, to a second base station, a handover request message including information for transferring an artificial intelligence (AI) model, determining a first AI model for transferring the AI model of the terminal based on a response message for a handover request and AI information of the terminal previously received from the terminal, the handover request including response information to the information for transferring the AI model received from the second base station, and transferring, to the terminal, the determined first AI model and a message for performing a handover.

In accordance with another aspect of the disclosure, a method performed by a terminal in a communication system is provided. The method includes transferring, to a first base station, a measurement report and receiving a first artificial intelligence (AI) model and a message for performing handover from the first base station, wherein the first AI model is an AI model determined for transferring an AI model of the terminal, based on AI information of the terminal and AI information of a second base station.

In accordance with another aspect of the disclosure, a method performed by a second base station in a communication system is provided. The method includes receiving, from a first base station, a handover request message including information for determining a first artificial intelligence (AI) model for transferring an AI model of a terminal and transferring, to the first base station, a response message to a handover request, the handover request including response information to information for determining the first AI model for transferring an AI model of the terminal, wherein the first AI model is an AI model determined with AI information of the terminal and AI information of the second base station.

In accordance with another aspect of the disclosure, a first base station in a communication system is provided. The first base station includes a transceiver configured to transmit and receive a signal, and a controller that controls to receive a measurement report from a terminal, transfer, to a second base station, a handover request message including information for transferring an artificial intelligence (AI) model, determine a first AI model for transferring the AI model of the terminal based on a response message for a handover request and AI information of the terminal previously received from the terminal, the handover request including response information to the information for transferring the AI model received from the second base station, and transfer, to the terminal, the determined first AI model and a message for performing a handover.

In accordance with another aspect of the disclosure, a terminal in a communication system is provided. The terminal includes a transceiver configured to transmit and receive a signal and a controller that controls to transfer, to a first base station, a measurement report, and receive, from the first base station, a first artificial intelligence (AI) model and a message for performing handover, wherein the first AI model is an AI model determined for transferring an AI model of the terminal, based on AI information of the terminal and AI information of a second base station.

In accordance with another aspect of the disclosure, a second base station in a communication system is provided. The second base station includes a transceiver configured to transmit and receive a signal, and a controller that controls to receive, from a first base station, a handover request message including information for determining a first artificial intelligence (AI) model for transferring an AI model of a terminal, and transfer, to the first base station, a response message to a handover request, the handover request including response information to information for determining the first AI model for transferring an AI model of the terminal, wherein the first AI model is an AI model determined with AI information of the terminal and AI information of the second base station.

The disclosed embodiment provides various methods for efficiently transferring or delivering an AI model during a handover process in a mobile communication system, and an apparatus capable of providing the method.

In accordance with another aspect of the disclosure, one or more non-transitory computer-readable storage media storing computer-executable instructions that, when executed by one or more processors individually or collectively, cause a first base station in a communication system to perform operations are provided. The operations include receiving a measurement report from a terminal, transferring, to a second base station, a handover request message including information for transferring an artificial intelligence (AI) model, determining a first AI model for transferring the AI model of the terminal based on a response message for a handover request and AI information of the terminal previously received from the terminal, the handover request including response information to the information for transferring the AI model received from the second base station, and transferring, to the terminal, the determined first AI model and a message for performing handover.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a diagram illustrating a structure of a long term evolution (LTE) system according to an embodiment of the disclosure;

FIG. 1B is a diagram illustrating a radio protocol structure in an LTE system according to an embodiment of the disclosure;

FIG. 1C is a diagram illustrating a structure of a next-generation mobile communication system according to an embodiment of the disclosure;

FIG. 1D is a diagram illustrating a radio protocol structure of a next-generation mobile communication system according to an embodiment of the disclosure;

FIGS. 2A and 2B are diagrams illustrating a method for transferring or delivering an AI model according to various embodiments of the disclosure;

FIG. 3 is a diagram illustrating a DL transfer or delivery method of an AI model according to an embodiment of the disclosure;

FIGS. 4A and 4B are diagrams illustrating an embodiment of a DL transfer or delivery method of an AI model described with reference to FIG. 3 according to various embodiments of the disclosure;

FIG. 5 is a diagram illustrating a UL transfer or delivery method of an AI model according to an embodiment of the disclosure;

FIGS. 6A and 6B are diagrams illustrating an embodiment of a UL transfer or delivery method of an AI model described with reference to FIG. 5 according to various embodiments of the disclosure;

FIG. 7 is a diagram illustrating a DL transfer or delivery method of an AI model by a source base station during handover according to an embodiment of the disclosure;

FIG. 8 is a diagram illustrating a DL transfer or delivery method of an AI model by a source base station during handover according to an embodiment of the disclosure;

FIG. 9 is a diagram illustrating a DL transfer or delivery method of an AI model by a target base station during handover according to an embodiment of the disclosure;

FIG. 10 is a diagram illustrating a UL transfer or delivery method of an AI model by a UE during handover according to an embodiment of the disclosure;

FIG. 11 is a diagram illustrating a UL transfer or delivery method of an AI model by a UE during handover according to an embodiment of the disclosure;

FIG. 12 is a diagram illustrating a UL transfer or delivery and DL transfer or delivery method of an AI model during handover according to an embodiment of the disclosure;

FIG. 13 is a block diagram illustrating a constitution of a UE according to an embodiment of the disclosure; and

FIG. 14 is a block diagram illustrating a constitution of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the description of embodiments of the disclosure, descriptions of techniques that are well known in the art and not directly related to the disclosure are omitted. This is to clearly convey the gist of the disclosure by omitting any unnecessary explanation.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Further, in describing the disclosure, a detailed description of known functions or configurations incorporated herein will be omitted when it is determined that the description may make the subject matter of the disclosure unnecessarily unclear. The terms which will be described below are terms defined based on the functions in the disclosure, and may be different according to users, intentions of the operators, or customs.

Therefore, the definitions of the terms should be made based on the contents throughout the specification.

Hereinafter, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or multimedia systems capable of performing communication functions. In the disclosure, a downlink (DL) refers to a radio link path via which a base station transfers a signal to a terminal, and an uplink (UL) refers to a radio link path via which a terminal transfers a signal to a base station. Further, in the following description, LTE or LTE-advanced (LTE-A) systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the 5G may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

Herein, it will be understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block(s). These computer program instructions may also be stored in a computer usable or computer-readable memory that may direct a computer or other programmable data processing apparatus to implement a function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block(s).

Further, each block may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software component or a hardware component, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the ‘unit’ includes, for example, components, such as software components, object-oriented software components, class components, and task components, processes, functions, properties, procedures, sub-routines, segments of a program code, drivers, firmware, micro-codes, circuits, data, database, data structures, tables, arrays, and parameters. The components and functions provided by the ‘unit’ may be either combined into a smaller number of components and a ‘unit’, or divided into additional components and a ‘unit’. Moreover, the components and ‘units’ may be implemented to reproduce one or more central processing units (CPUs) within a device or a security multimedia card. Further, in the embodiments of the disclosure, the ‘^{˜}unit’ may include one or more processors. Hereinafter, a/b may be understood as at least one of a or b.

In addition, various embodiments of the disclosure will be described below using a system based on LTE, LTE-A, NR, or 6G as an example, but the various embodiments of the disclosure may also be applied to other communication systems with similar technical background or channel type. In addition, the various embodiments of the disclosure may be applied to other communication systems through some modifications without significantly departing from the scope at the discretion of a person with skilled technical knowledge.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

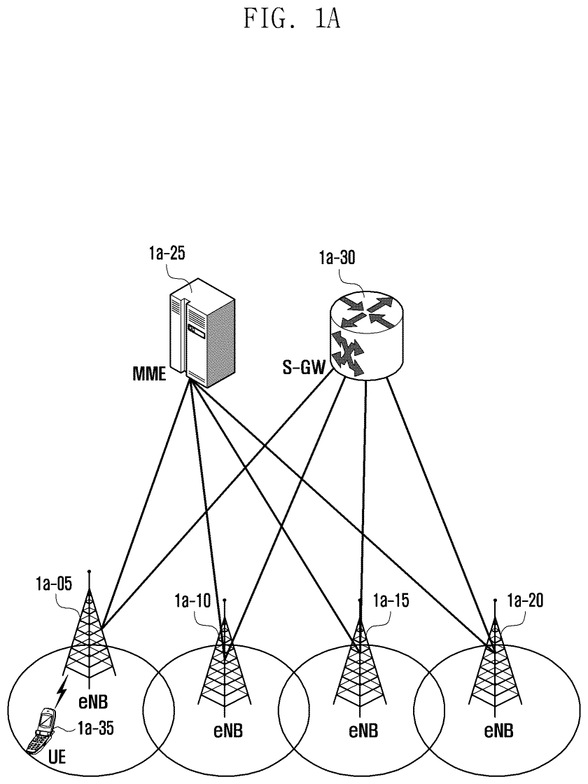

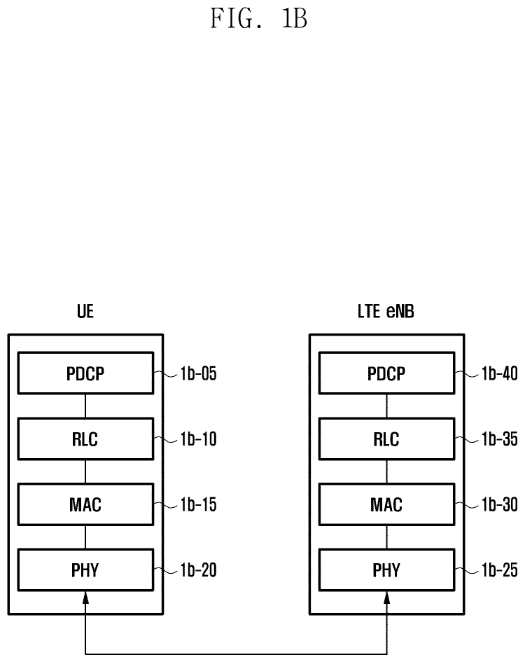

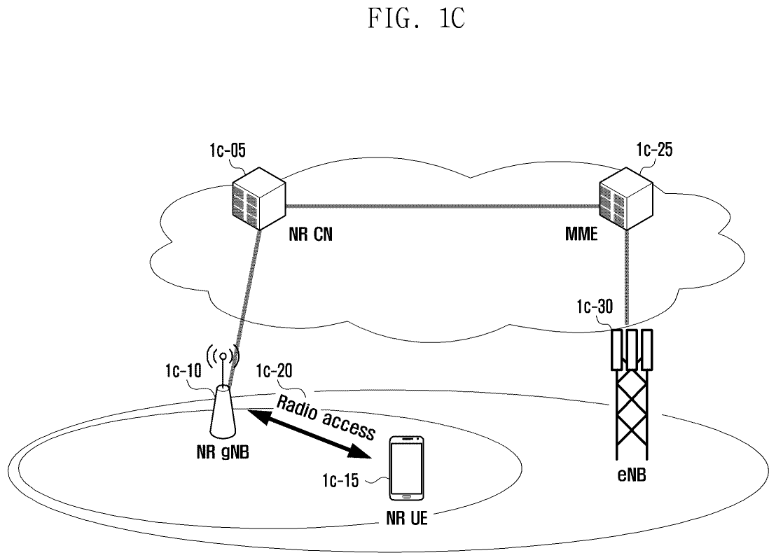

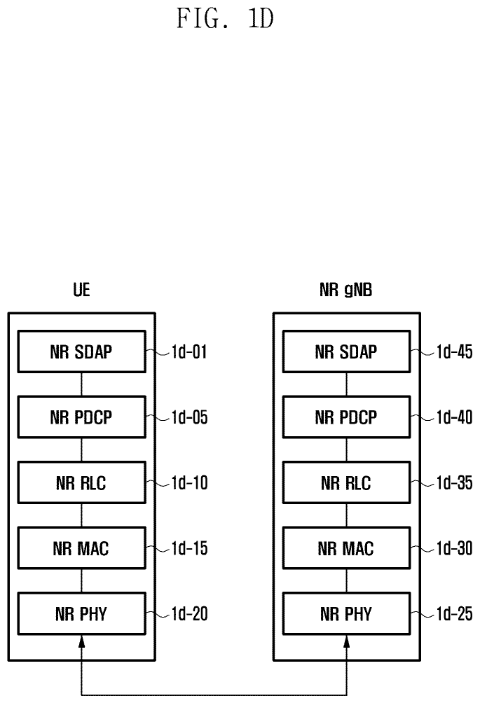

FIG. 1A is a diagram illustrating a structure of an LTE system according to an embodiment of the disclosure.

Referring to FIG. 1A, as illustrated, a radio access network of an LTE system includes a next-generation base stations (evolved node B, hereinafter, eNB, Node B, or base station) 1a-05, 1a-10, 1a-15, and 1a-20, a mobility management entity (MME) 1a-25, and a serving-gateway (S-GW) 1a-30. A user equipment (hereinafter, UE or terminal) 1a-35 is connected to an external network through the eNBs 1a-05 to 1a-20 and S-GW 1a-30.

Referring to FIG. 1A, the eNBs 1a-05 to 1a-20 correspond to the existing node B of a universal mobile telecommunications system (UMTS) system. The eNBs are connected to the UE 1a-35 through a radio channel and perform more complicated role than the existing node B. In the LTE system, in addition to a real-time service like a voice over Internet protocol (VOIP) through the Internet protocol, all the user traffics are served through a shared channel and therefore a device for collecting and scheduling status information, such as a buffer status, an available transmission power status, and a channel state of the UEs is required. Here, the eNBs 1a-05 to 1a-20 take charge of the collecting and scheduling. One eNB generally controls a plurality of cells. For example, to implement a transmission rate of 100 Mbps, the LTE system uses, as a radio access technology, orthogonal frequency division multiplexing (hereinafter, OFDM) in, for example, a bandwidth of 20 MHz. Further, an adaptive modulation & coding (hereinafter, AMC) scheme determining a modulation scheme and channel coding rate depending on a channel status of the UE is applied. The S-GW 1a-30 is an entity for providing a data bearer and generates or removes the data bearer according to the control of the MME 1a-25. The MME 1a-25 is an entity for performing a mobility management function for the UE and various control functions and is connected to a plurality of base stations.

FIG. 1B is a diagram illustrating a radio protocol structure in an LTE system according to an embodiment of the disclosure.

Referring to FIG. 1B, the radio protocol of the LTE system consists of packet data convergence protocols (PDCPs) 1b-05 and 1b-40, radio link controls (RLCs) 1b-10 and 1b-35, and medium access controls (MACs) 1b-15 and 1b-30 in the UE and the eNB, respectively. The PDCPs 1b-05 and 1b-40 take charge of the operation of the IP header compression/recovery, or the like. The main functions of the PDCP are summarized as follows.
Header compression and decompression function: robust header compression (ROHC) only
Transfer function of user data
In-sequence delivery function (In-sequence delivery of upper layer protocol data units (PDUs) at PDCP re-establishment procedure for RLC acknowledged mode (AM))
Reordering function (For split bearers in dual connectivity (DC) (only support for RLC AM): PDCP PDU routing for transmission and PDCP PDU reordering for reception)
Duplicate detection function (Duplicate detection of lower layer service data units (SDUs) at PDCP re-establishment procedure for RLC AM)
Retransmission function (Retransmission of PDCP SDUs at handover and, for split bearers in DC, of PDCP PDUs at PDCP data-recovery procedure, for RLC AM)
Ciphering and deciphering functions
Timer-based SDU discard function (Timer-based SDU discard in uplink.)

The radio link control (hereinafter referred to as RLC) 1b-10 and 1b-35 reconstitutes the PDCP packet data unit (PDU) at an appropriate size to perform an automatic repeat request (ARQ) operation, or the like. The main function of the RLC is summarized as follows.
Data transfer function (Transfer of upper layer PDUs)
ARQ function (Error Correction through ARQ (only for AM data transfer))
Concatenation, segmentation and reassembly functions (Concatenation, segmentation and reassembly of RLC SDUs (only for unacknowledged mode (UM) and AM data transfer))
Re-segmentation function (Re-segmentation of RLC data PDUs (only for AM data transfer))
Reordering function (Reordering of RLC data PDUs (only for UM and AM data transfer))
Duplicate detection function (Duplicate detection (only for UM and AM data transfer))
Error detection function (Protocol error detection (only for AM data transfer))
RLC SDU discard function (RLC SDU discard (only for UM and AM data transfer))
RLC re-establishment function (RLC re-establishment)

The MACs 1b-15 and 1b-30 are connected to several RLC layer entities constituted in one UE and performs an operation of multiplexing RLC PDUs in a MAC PDU and demultiplexing the RLC PDUs from MAC PDU. The main function of MAC is summarized as follows.
Mapping function (Mapping between logical channels and transport channels)
   Multiplexing and demultiplexing functions (Multiplexing/demultiplexing of MAC SDUs belonging to one or different logical channels into/from transport blocks (TB) delivered to/from the physical layer on transport channels)
Scheduling information reporting function (Scheduling information reporting)
Hybrid ARQ (HARQ) function (Error correction through HARQ)
Priority handling function between logical channels (Priority handling between logical channels of one UE)
Priority handling function between UEs (Priority handling between UEs by means of dynamic scheduling)
Multimedia broadcast multicast service (MBMS) service identification (ID) function (MBMS service identification)
Transport format selection function (Transport format selection)
Padding function (Padding)

Physical layers 1b-20 and 1b-25 perform an operation of channel-coding and modulating upper layer data, making them as an OFDM symbol, and transferring them to the radio channel or an operation of demodulating the OFDM symbol received through the radio channel, channel-decoding it, and delivering it to an upper layer. In addition, the physical layers also use hybrid ARQ (HARQ) to additionally correct errors, where the reception stage transfers 1 bit as to whether the reception stage receives the packets transferred from the transmission stage, which is called HARQ acknowledgment (ACK)/negative ACK (NACK). Downlink HARQ ACK/NACK information in response to UL transfer is transferred via physical Hybrid-ARQ indicator channel (PHICH). Uplink HARQ ACK/NACK information in response to downlink transfer is transferred via physical uplink control channel (PUCCH) or physical uplink shared channel (PUSCH) physical channel.

Meanwhile, the physical (PHY) layer may include one or a plurality of frequencies/carriers and a technology for simultaneously configuring and using a plurality of frequencies is called carrier aggregation (hereinafter referred to as CA). According to the CA technology, instead of using only one carrier for communication between a terminal (or user equipment (UE)) and a base station (evolved UMTS terrestrial radio access network (E-UTRAN) NodeB (eNB)), a primary carrier and one or a plurality of secondary carriers are used additionally and thus data capacity may be greatly increased by the number of secondary carriers. Meanwhile, in LTE, a cell served by the base station using the primary carrier is called a primary cell (PCell) and a cell served by the base station using the secondary carrier is called a secondary cell (SCell).

Although not illustrated in the drawing, radio resource control (hereinafter, referred to as RRC) layers exist above the PDCP layers of the UE and base station, respectively, and the RRC layers may exchange configuration control messages related to access and measurement for the sake of radio resource control.

FIG. 1C is a diagram illustrating a structure of a next-generation mobile communication system according to an embodiment of the disclosure.

Referring to FIG. 1C, a radio access network of the next-generation mobile communication system may include a next-generation base station (new radio node B (hereinafter, NR gNB) 1c-10 and a new radio core network (NR CN) or next-generation core network (NG CN) 1c-05. A new radio user equipment (hereinafter NR UE or UE) 1c-15 accesses an external network 1c-20 via the NR gNB 1c-10 and NR CN 1c-05.

Referring to FIG. 1C, the NR gNB 1c-10 corresponds to an evolved node B (eNB) of an existing LTE system. The NR gNB 1c-10 is connected to the NR UE 1c-15 through radio channels and may provide superior services compared to an existing node B. Since all user traffic is serviced through shared channels in the next-generation mobile communication system, a device for collecting buffer status information of UEs, available transfer power status information, channel status information, or the like, and performing scheduling is required and the NR gNB 1c-10 serves as such a device. A single NR NB generally controls multiple cells. A bandwidth greater than the maximum bandwidth of existing LTE may be given to achieve an ultrahigh data rate, and beamforming technology may be added to radio access technology, such as orthogonal frequency-division multiplexing scheme (hereinafter referred to as OFDM). In addition, adaptive modulation & coding (hereinafter referred to as AMC) scheme is also used to determine a modulation scheme and a channel coding rate in accordance with a channel status of the UE. The NR CN 1c-05 performs functions, such as mobility support, bearer configuration, quality of service (QOS) configuration, and the like. The NR CN is an entity for performing a mobility management function and various control functions for the UE and is connected to a plurality of base stations. In addition, the next-generation mobile communication system may cooperate with the existing LTE system, and the NR CN is connected to an MME 1c-25 through a network interface. The MME is connected to an existing base station, eNB 1c-30.

FIG. 1D is a diagram illustrating a radio protocol structure of a next-generation mobile communication system according to an embodiment of the disclosure.

Referring to FIG. 1D, the radio protocol of the next-generation mobile communication system includes NR service data adaptation protocols (SDAPs) 1d-01 and 1d-45, NR PDCPs 1d-05 and 1d-40, NR RLCs 1d-10 and 1d-35, and NR MACs 1d-15 and 1d-30 in the UE and the NR base station, respectively.

The main function of the NR SDAP 1d-01 and 1d-45 may include some of the following functions.
Transfer function of user data (transfer of user plane data)
Mapping function between a QoS flow and a data radio bearer (DRB) for both DL and UL (mapping between a QoS flow and a DRB for both DL and UL)
Marking function of QoS flow ID for both DL and UL (marking QoS flow ID in both DL and UL packets)
Mapping function of reflective QoS flow to data bearer for UL SDAP PDUs (reflective QoS flow to DRB mapping for the UL SDAP PDUS).

For the SDAP layer entity, the UE can be configured with regard to whether to use the header of the SDAP layer entity or the function of the SDAP layer entity for each PDCP layer entity, for each bearer, or for each logical channel through an RRC message, and in case where the SDAP header is configured, the non access stratum (NAS) QoS reflection configuration 1-bit indicator (NAS reflective QoS) of the SDAP header and the access stratum (AS) QoS reflection configuration 1-bit indicator (AS reflective QoS) may indicate that the UE can update or reconfigure the QoS flow of uplink and downlink and mapping information for the data bearer. The SDAP header may include QoS flow ID information indicating QoS. The QoS information may be used as data-processing priority, scheduling information, and the like to support smooth service.

The main function of the NR PDCP 1d-05 and 1d-40 may include some of the following functions.
Header compression and decompression functions (Header compression and decompression: ROHC only)
Transfer function of user data (Transfer of user data)
In-sequence delivery function (In-sequence delivery of upper layer PDUs)
Out-of-sequence delivery function (Out-of-sequence delivery of upper layer PDUs)
Reordering function (PDCP PDU reordering for reception)
Duplicate detection function (Duplicate detection of lower layer SDUs)
Retransmission function (Retransmission of PDCP SDUs)
Ciphering and deciphering functions (Ciphering and deciphering)
Timer-based SDU discard function (Timer-based SDU discard in uplink.)

In the above, the reordering function of the NR PDCP entity refers to a function of reordering PDCP PDUs received from a lower layer, on a PDCP sequence number (SN) basis and may include a function of delivering the reordered data to an upper layer in order, a function of delivering immediately data without considering the order, a function of recording missing PDCP PDUs by reordering the PDCP PDUs, a function of reporting status information of the missing PDCP PDUs to a transmitter, and a function of requesting to retransfer the missing PDCP PDUs.

The main function of NR RLCs 1d-10 and 1d-35 may include some of the following functions.
Data transfer function (Transfer of upper layer PDUs)
In-sequence delivery function (In-sequence delivery of upper layer PDUs)
Out-of-sequence delivery function (Out-of-sequence delivery of upper layer PDUs)
ARQ function (Error Correction through ARQ)
Concatenation, segmentation and reassembly functions (Concatenation, segmentation and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU discard function (RLC SDU discard)
RLC re-establishment function (RLC re-establishment)

In the above, the in-sequence delivery function of the NR RLC entity refers to a function of delivering RLC SDUs received from a lower layer, to an upper layer in order and may include a function of reassembling multiple RLC SDUs segmented from a RLC SDU and delivering the RLC SDU in case where the segmented RLC SDUs are received, a function of reordering received RLC PDUs on a RLC sequence number (SN) or PDCP SN basis, a function of recording missing RLC PDUs by reordering the RLC PDUs, a function of reporting status information of the missing RLC PDUs to a transmitter, a function of requesting to retransfer the missing RLC PDUs, a function of delivering only RLC SDUs previous to a missing RLC SDU, to the upper layer in order, in case where the missing RLC SDU exists, a function of delivering all RLC SDUs received before a timer is started, to the upper layer in order, although a missing RLC SDU exists, when a certain timer is expired, or a function of delivering all RLC SDUs received up to a current time, to the upper layer in order, although a missing RLC SDU exists, when a certain timer is expired. In addition, the NR RLC entity may process the RLC PDUs in order of reception (in order of arrival regardless of serial numbers or sequence numbers) and deliver the RLC PDUs to a PDCP entity out of order (out-of-sequence delivery), and receive the segments stored in a buffer or to be received later in case of segment and reassemble the received segments into a whole RLC PDU, and then, process and deliver the RLC PDU to the PDCP entity. The NR RLC layer may not have a concatenation function, and the concatenation function may be performed by the NR MAC layer or be replaced with a multiplexing function of the NR MAC layer.

In the above, the out-of-sequence delivery function of the NR RLC entity refers to a function of delivering the RLC SDUs received from the lower layer, to the upper layer out of order and may include a function of reassembling multiple RLC SDUs segmented from one RLC SDU and delivering the RLC SDU in case where the segmented RLC SDUs are received, or a function of storing RLC SNs or PDCP SNs of received RLC PDUs and recording missing RLC PDUs by ordering the RLC PDUs.

The NR MACs 1d-15 and 1d-30 may be connected to various NR RLC layer entities constituted in one UE, and the main function of the NR MAC may include some of the following functions.
Mapping function (Mapping between logical channels and transport channels)
   Multiplexing and demultiplexing function (Multiplexing/demultiplexing of MAC SDUs)
Scheduling information reporting function (Scheduling information reporting)
HARQ function (Error correction through HARQ)
Priority handling function between logical channels (Priority handling between logical channels of one UE)
Priority handling function between UEs (Priority handling between UEs by means of dynamic scheduling)
MBMS service identification function (MBMS service identification)
Transport format selection function (Transport format selection)
Padding function (Padding)

A NR PHY layer 1d-20 and 1d-25 may channel-code and modulate upper layer data into OFDM symbols and transfer the OFDM symbols through a radio channel, or demodulate OFDM symbols received through a radio channel and channel-decode and deliver the OFDM symbols to an upper layer.

Hereinafter, in an embodiment of the disclosure, a method for transferring and delivering an AI model, which is a process of transferring an AI model structure and parameter between a UE and a network or network entity during the operation of an AI technology, will be described, and the transfer or delivery method of the AI model during handover will be described. Here, the handover of the disclosure may be a conditional handover (CHO) or a network handover (baseline handover, dual active protocol stacks (DAPS) handover, or the like).

The case where the transfer or delivery of an AI model may occur may vary, such as a case where an update is required due to performance deterioration of the AI model, a case where AI model transfer occurs using different AI models in a multi-vendor situation where vendors, such as UEs or base stations are different, a case where AI model transfer occurs due to the characteristics of a cell-specific AI model, and a case where AI model transfer occurs due to a difference in whether or not AI is supported for each base station. Here, the case in which the vendors of the UEs or base stations are different may mean, for example, a case where the base station is provided by a plurality of vendors, a case where each of a plurality of UEs is the UE provided by a plurality of vendors, and the like.

For example, during handover, AI model transfer may occur due to a case where different AI models are used between multi-vendors, due to a difference in the characteristics of cell-specific AI models, and due to a difference in whether or not an AI model is supported for each base station.

In addition, with regard to options for transferring or delivering an AI model, even within one option, a determination for an order in which models will be transferred and which detailed option of control plane (CP) or user plane (UP) is used may be needed.

Since a target base station that communicates with the UE after handover has no information about the AI between the UE before a random access (RA) process and the target base station at all, in the case of using the existing communication system and handover procedure, the efficient use of AI model transfer and AI model delivery may not be possible during handover.

For example, in the case of using the existing communication system and handover procedure, even in the case of the same AI model is transferred redundantly or AI model is not applied to a specific use case at a specific base station or UE, although this case is not a supported case, unnecessary transfer may be performed. In addition, it may not be possible to preferentially manage cases of performance degradation, and it may not be possible to consider the priority of AI model transfer.

The disclosure is to define information to be used for efficient AI model transfer or delivery in each UE and base station, and to efficiently transfer and deliver the AI model through a signaling operation between the UE and the base station. In addition, the disclosure defines signaling between the UE and the base station and operations between the base stations to efficiently use limited radio resources during handover and efficiently transfer and deliver an AI model.

Regarding cases using AI models, three cases are being discussed: channel state indicator (CSI), beam management (BM), and positioning. Regarding the use of AI technology, there may be a one-sided case where AI inference is performed on the network or UE, or a two-sided case where AI inference is performed on the UE and network separately and an output of one entity is used as an input of the other entity. The examples of this disclosure are not limited to the three examples above, and can also be applied to various cases where AI models are used.

Hereinafter, in the disclosure, transfer of an AI model may mean transferring parameters of an existing AI model structure or an updated new AI model from a base station to a UE through a radio interface. Additionally, the transfer of an AI model may be the transfer from the UE to the base station. Here, the entity transferring the AI model to the UE is not limited to the base station, and may be an external server or a network entity.

Hereinafter, in the disclosure, delivering an AI model may mean delivering the AI model from one entity to another entity, or delivering the AI model through an interface other than a radio interface. For example, delivering an AI model may mean delivering parameters of the structure of an existing AI model or an updated new AI model from a target base station to a source base station during handover. Here, the AI model between respective entities may be delivered through an Xn interface.

In addition, hereinafter, the transfer or delivery of the AI model in the disclosure may be the transfer or delivery of the AI model itself, that is, the transfer or delivery of the structure of the AI model. In a case where the AI model is updated and some parameters are changed, it may be the transfer or delivery of some of the AI model including only the changed parameters. Here, the parameter may be, for example, a weight value of an AI model, or may be a weight value determined according to the results of learning the AI model.

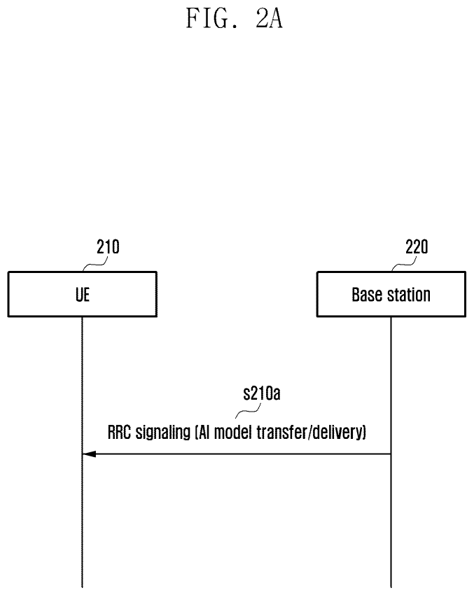

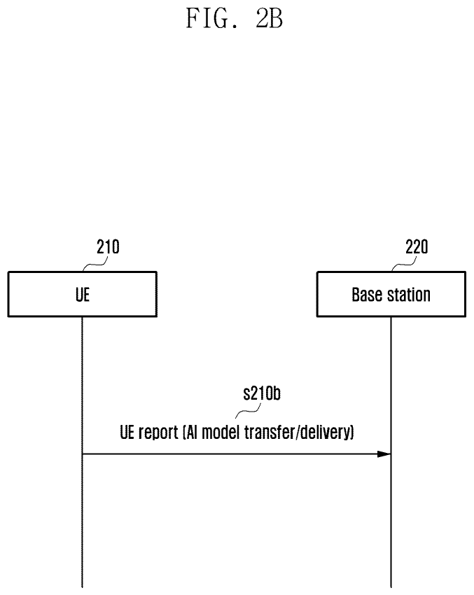

FIGS. 2A and 2B are diagrams illustrating a method for transferring or delivering an AI model according to various embodiments of the disclosure. FIGS. 2A and 2B illustrate one embodiment of transfer or delivery of one-sided AI model.

Referring to FIG. 2A, in operation S210a, a base station 220 may transfer an RRC signaling message to a UE 210. Here, an AI model may be included in the RRC signaling message, or the AI model may be transferred together with the RRC signaling message.

Referring to FIG. 2B, in operation S210b, the UE 210 may transfer a report to the base station 220. Here, the report may be any report, for example, a measurement report. The UE 210 may transfer or deliver the report including the AI model to the base station 220, or transfer or deliver the report and the AI model together.

Here, any report transferred from the UE to the base station is not necessarily limited to a measurement report, and any message may be transferred from the UE to the base station. For example, examples of the above messages may include a capability report message in which the UE reports its capabilities to the base station, and a measurement report message in which the UE reports signal measurement results to the base station.

According to an embodiment of the disclosure, the AI model may be transferred or delivered bidirectionally between the UE 210 and the base station 220. In this case, an inference result value using the AI model on the UE 210 may be used in the base station 220, and an inference result value using the AI model on the base station 220 may be used in the UE 210.

According to an embodiment of the disclosure, examples of one-sided AI model transfer may include cases of CSI estimation, beam prediction, or positioning. An example of two-sided AI model transfer may be the case of CSI compression.

In the process case of transferring or delivering the AI model between the UE and the base station, or the UE and the network, various detailed options may exist, and may be classified as Option 1 which is the transfer between the UE and the base station, Option 2 which is the transfer between the UE and a core network, Option 3 which is the transfer between the UE and a location management function (LMF), and Option 4 which is the transfer between the UE and an external server. Among these, in the case of Option 1, when the base station transfers the AI model to the UE, transfer through RRC signaling of the CP may be considered. In the case of Option 1-CP, the transfer of the AI model may be performed similarly to the handover procedure. In addition, the corresponding Option 1-CP has characteristics, such as the transfer of the AI model within limited latency. For example, FIG. 2A of the disclosure may illustrate the case of Option 1-CP.

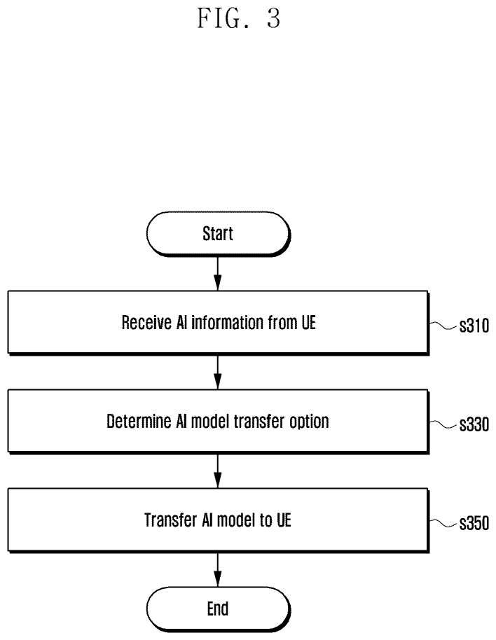

FIG. 3 is a diagram illustrating a DL transfer or delivery method of an AI model according to an embodiment of the disclosure.

Hereinafter, in describing the method according to this embodiment of the disclosure, description of an entity performing some operations may be omitted. In this case, the entity performing the corresponding operation may be a base station. However, the disclosure is not limited thereto, and in the method according to the embodiment of the disclosure, the entity performing some operations may be any one of a base station, a core network entity, an LMF, and an external server.

Referring to FIG. 3, in operation s310, the base station may receive AI information from the UE. In this case, the base station may receive AI information from the UE through a radio interface. For example, the base station may receive AI information included in the measurement report from the UE.

Hereinafter, in the disclosure, AI information or AI information message may be a plurality of pieces of information related to AI used by a UE, a base station or each node of a wireless communication network or a message including the plurality of pieces of information related to AI. For example, a target base station may receive the AI information of the UE from a source base station, obtain information about the AI of the UE, which is the subject to which the AI model is to be transferred, and transfer the AI model of the target base station about specific cases (e.g., CSI estimation) from the target base station to the UE. In other words, the AI information may be information for a subject wishing to transfer or deliver an AI model to determine the AI model to be transferred or delivered based on information related to the AI of a target receiving the AI model.

The AI information may be used to select an option to be used for transfer of the AI model. The AI information may be used to configure priority for transferring or delivering AI models in situations where latency is limited or according to a case where transfer data size is limited in the case of transferring through CP; the AI information may be used to determine the AI model to perform an update, and may be used to transfer or deliver the AI model during handover; and the AI information may be used to select periodic or aperiodic transfer (or delivery) options. Here, aperiodic transfer may mean transfer of an updated AI model, for example, in a case where performance deterioration of the AI model is detected.

Hereinafter, in the disclosure, AI information or AI information message may include at least one of the following pieces of information.
AI model name: information that may determine whether or not an AI model needs to be transferred depending on whether the AI models of respective entities are the same in determining whether to transfer or deliver the AI model between the respective entities. For example, in a case where the AI models of respective entities are the same, it may determine that the transfer of the AI model is unnecessary. For example, here, the AI model name may be the identification (ID) of the AI model and may include updated version information of the AI model.
AI model size: information that may determine whether the UE or base station may transfer an AI model through a radio interface according to a size of the AI model, for example, information that may determine whether the base station may transfer the AI model to the UE through RRC signaling or downlink control indicator (DCI). Alternatively, information that may determine whether the UE or base station transfers the AI model through CP or UP according to the size of the AI model.
Use case requirement: information that may allow for the UE or base station to determine the priority of the AI model transfer according to requirements, based on latency sensitivity, or the like.
AI support case: information that may determine that transfer of the AI model is unnecessary in a case where a specific case corresponds to a case in which the AI model is not supported. For example, in a case where the UE supports an AI model for CSI estimation, but the base station connected to the UE does not support the AI model for CSI estimation, transferring the AI model from the UE to the base station may be unnecessary for the corresponding case.
Case requiring update: information that may judge whether update is needed for each case and determine a priority of the transfer or delivery of the AI model, based on information about whether the case requires an update for each entity.
Vendor information: information that may determine the vendor information of a UE or entity and consider the need for AI model transfer. For example, in a case where the base station is constituted by a plurality of vendors, information on the corresponding plurality of vendors.
AI operating layer information: information that may be used to determine a transfer option depending on which layer the AI model operates at. For example, in a DL transfer case, in Option 1 case, a gNB may directly transfer the AI model to the UE, and in Option 4 case, an external server may directly transfer the AI model to the UE. For example, in a UL transfer case, in a case where the AI model is a model that operates on the PHY layer, the corresponding AI model may be transferred from the UE to the gNB, and in a case where the AI model is a model that operates on the server, the AI model may be transferred directly from the UE to the server.

In operation s330, the base station may determine whether to transfer an AI model to the UE, AI model transfer option, and AI model transfer priority, based on the AI information or AI information message received from the UE, and may perform scheduling for AI model transfer.

In operation s350, the base station may transfer the AI model to the UE according to the determined AI model transfer option.

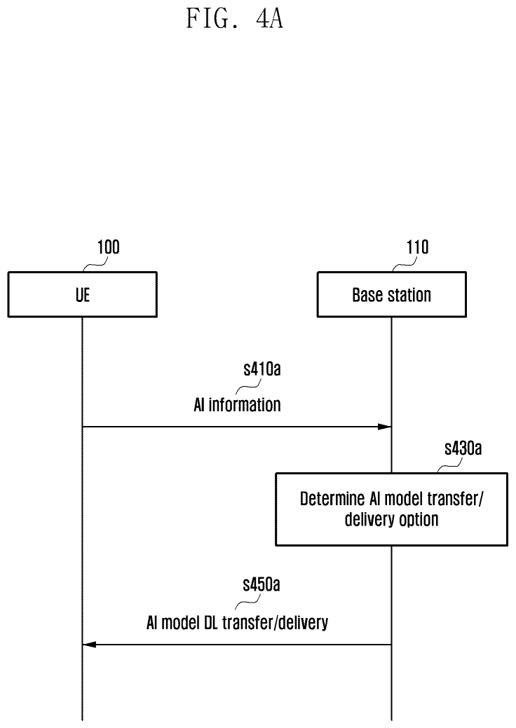

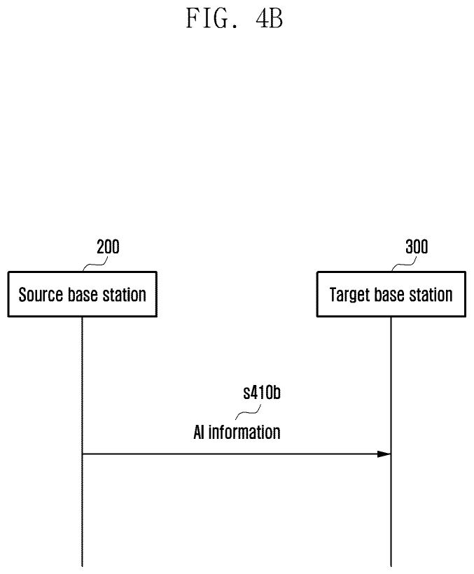

FIGS. 4A and 4B are diagrams illustrating an embodiment of a DL transfer or delivery method of an AI model described with reference to FIG. 3 according to various embodiments of the disclosure.

Referring to FIG. 4A, in operation s410a, a UE 100 may transfer the AI information message to a base station 110. The AI information message may include the AI information described above.

According to an embodiment of the disclosure, when transferring a report (e.g., measurement report) to the base station 110, the UE 100 may transfer AI information along with the report. Alternatively, the UE 100 may transfer the report and AI information message to the base station 110 simultaneously or sequentially.

In operation s430a, the base station 110 may determine an AI model transfer or delivery option based on the AI information received from the UE 100.

According to an embodiment of the disclosure, the AI model transfer or delivery option may be any one of Options 1 to 4 described above.

According to an embodiment of the disclosure, the AI model transfer or delivery option that the base station 110 may determine may be an option related to an entity transferring the AI model during handover. For example, in operation s450a, the base station 110 may select either an option transferred by a source base station to the UE 100 or an option transferred by a target base station to the UE 100 as the AI model transfer or delivery option.

According to an embodiment of the disclosure, based on AI information, the base station 110 may determine a transfer option that comprehensively considers, for example, AI model transfer priority, AI support case, case requiring update, vendor information, or the like. For example, here, the transfer option may be an option regarding whether to transfer the AI model and transfer priority information of the AI model.

A case in which the base station 110 selects an option to determine a target base station as an AI model transfer entity or AI model determining entity during handover will be described with reference to FIG. 4B. Here, the base station 110 may be a source base station 200.

Referring to FIG. 4B, in operation s410b, the source base station 200 may deliver AI information to a target base station 300.

According to an embodiment of the disclosure, the target base station 300 may determine an AI model to be transferred to the UE 100 based on the received AI information, and may deliver the determined AI model to the source base station 200.

According to an embodiment of the disclosure, the target base station 300 may transfer a suitable updated AI model directly to the UE 100 based on the received AI information.

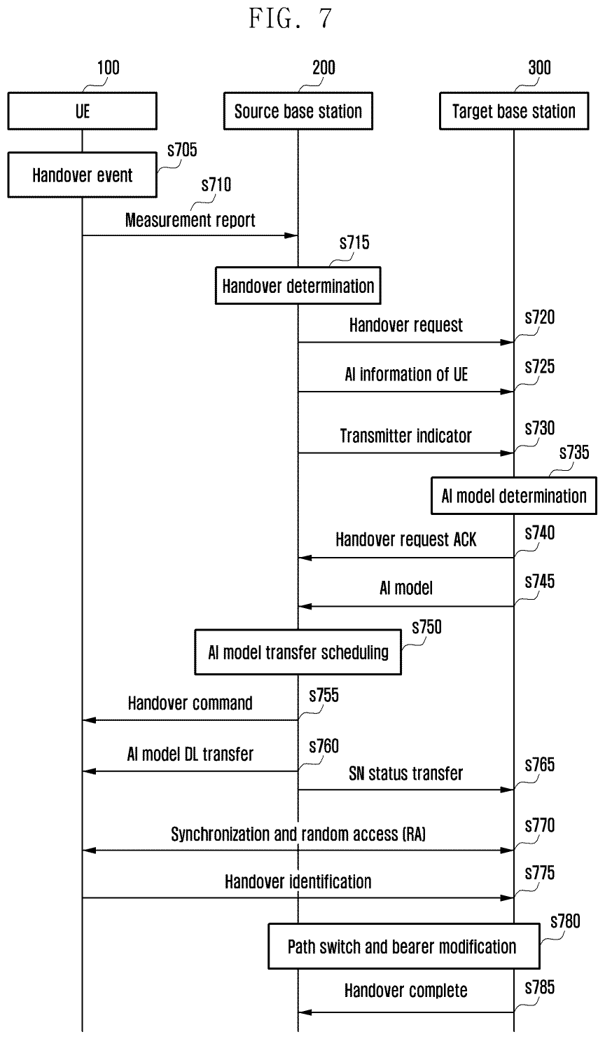

The transfer or delivery of the AI model during handover will be described later in FIGS. 7 to 12.

With reference again to FIG. 4A, in operation s450, the base station 110 may transfer the AI model to the UE 100 according to the determined AI model transfer option. Thereafter, the UE 100 may update the existing AI model of the UE 100 with the received AI model.

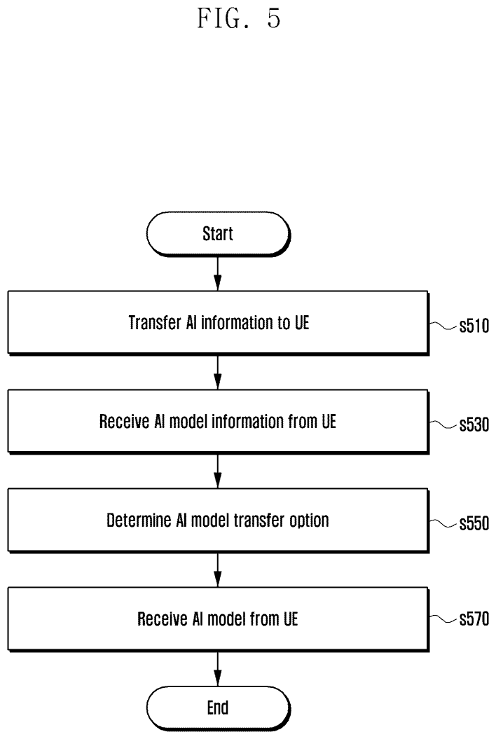

FIG. 5 is a diagram illustrating a UL transfer or delivery method of an AI model according to an embodiment of the disclosure.

Hereinafter, in describing the method according to this embodiment of the disclosure, description of an entity performing some operations may be omitted. In this case, the entity performing the corresponding operation may be a base station. However, the disclosure is not limited thereto, and in the method according to the embodiment of the disclosure, the entity performing some operations may be any one of a base station, a core network entity, an LMF, and an external server.

Referring to FIG. 5, in operation s510, the base station may transfer AI information to the UE. In this case, the base station may transfer AI information to the UE through a radio interface. For example, the base station may transfer AI information to the UE through RRC signaling.

The AI information may be used to select an option to be used for transfer of the AI model. The AI information may be used to configure priority for transferring or delivering AI models in situations where latency is limited; the AI information may be used to determine the AI model to perform an update, and may be used to transfer or deliver the AI model during handover; and the AI information may be used to select periodic or aperiodic transfer (or delivery) options. Here, aperiodic transfer may mean transfer of an updated AI model, for example, in a case where performance deterioration of the AI model is detected.

Hereinafter, in the disclosure, AI information or AI information message may include at least one of the following pieces of information.
AI model name: information that may determine whether or not an AI model needs to be transferred depending on whether the AI models of respective entities are the same in determining whether to transfer or deliver the AI model between the respective entities. For example, in a case where the AI models for a UE and a base station are the same, it may determine that the transfer of the AI model is unnecessary. For example, here, the AI model name may be the identification (ID) of the AI model and may include updated version information of the AI model.
AI model size: information that may determine whether the UE or base station may transfer an AI model through a radio interface according to a size of the AI model, that is, information that may determine whether the UE or base station may transfer the AI model through RRC signaling. Alternatively, information that may determine whether the UE or base station transfers the AI model through CP or UP according to the size of the AI model.
Use case requirement: information that may allow the UE or base station to determine the priority of the AI model transfer according to requirements, based on latency sensitivity, or the like.
   AI support case: information that may determine that transfer of the AI model is unnecessary in a case where a specific case corresponds to a case in which the AI model is not supported. For example, in a case where the UE supports an AI model for CSI estimation, but the base station connected to the UE does not support the AI model for CSI estimation, transferring the AI model from the UE to the base station may be unnecessary for the corresponding case.
   Case requiring update: information that may judge whether update is needed for each case and determine a priority of the transfer or delivery of the AI model, based on information about whether the case requires an update for each entity.
   Vendor information: information that may determine the vendor information of a UE or entity and consider the need for AI model transfer. For example, in a case where the base station is constituted by a plurality of vendors, vender information of the corresponding plurality of vendors.
   AI operating layer information: information that may determine a transfer option depending on which layer the corresponding AI model operates at. For example, in a DL transfer case, in Option 1 case, a gNB may directly transfer the AI model to the UE, and in Option 4 case, an external server may directly transfer the AI model to the UE. For example, in a UL transfer case, in a case where the AI model is a model that operates on the PHY layer, the corresponding AI model may be transferred directly from the UE to the gNB, and in a case where the AI model is a model that operates on the server, the AI model may be transferred directly from the UE to the server.

In operation s530, the base station may receive the AI model information from the UE.

Hereinafter, in the disclosure, in a case where the UE determines an AI model that performs UL transfer to the base station, the AI model information may be information including the type of option for transferring or delivering the corresponding AI model, the priority of the AI model, scheduling information, or the like. The base station may determine AI model transfer option, AI model priority, and/or AI model transfer schedule, based on the corresponding AI model information from the UE.

Hereinafter, in the disclosure, AI model information or AI model information message may include at least one piece of the following information.
A name of an AI model scheduled to be transferred by the UE,
A size of an AI model scheduled to be transferred by the UE,
Use case requirements for an AI model scheduled to be transferred by the UE,
AI support case for an AI model scheduled to be transferred by the UE,
Case requiring update for an AI model scheduled to be transferred by the UE,
Vendor information about an AI model scheduled to be transferred by the UE, and
AI operation layer information of an AI model scheduled to be transferred by the UE

In operation s550, the base station may determine AI model transfer option, and AI model transfer priority, based on the AI model information received from the UE, and may perform scheduling for UL transfer of the AI model from the UE to the base station based on the determined AI model transfer option and/or AI model transfer priority.

In operation s570, the base station may receive the AI model from the UE. Here, the UE may transfer the AI model to the base station based on the UL scheduling of the base station.

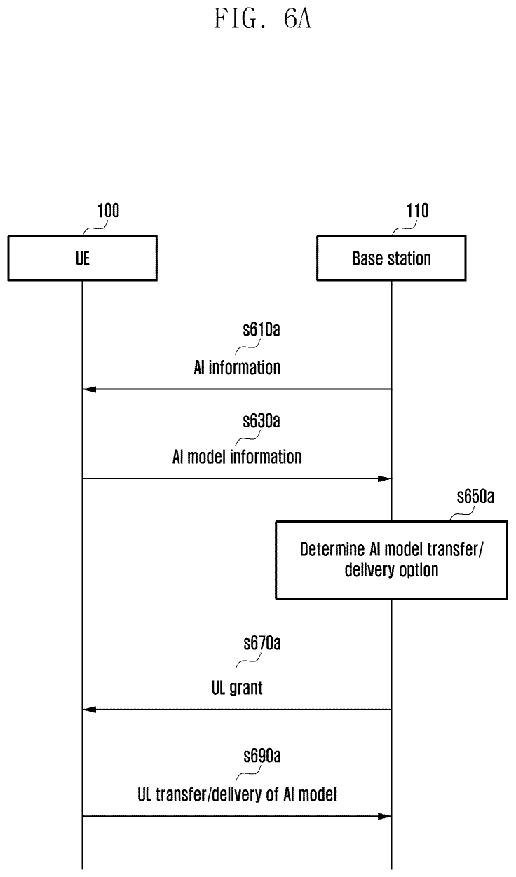

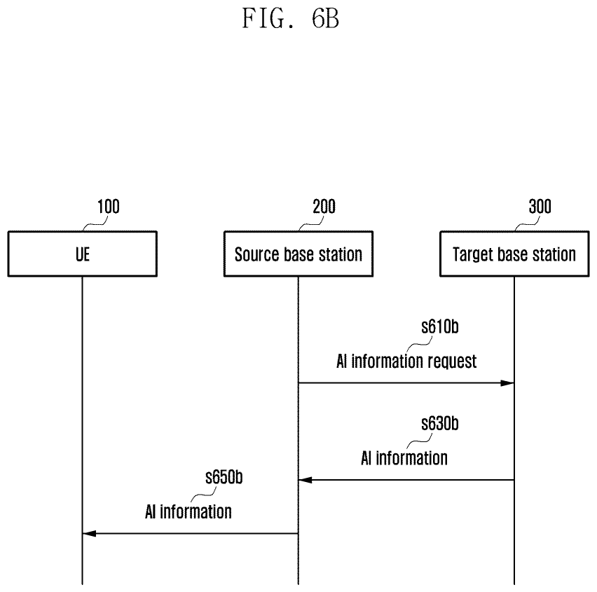

FIGS. 6A and 6B are diagrams illustrating an embodiment of the UL transfer or delivery method of the AI model described with reference to FIG. 5 according to various embodiments of the disclosure.

Referring to FIG. 6A, in operation s610a, the base station 110 may transfer the AI information to the UE 100. The AI information may be transferred through a radio interface, for example, through RRC signaling.

In operation s630a, the UE 100 may transfer the AI model information based on the AI information received from the base station 110.

According to an embodiment of the disclosure, the UE 100 may determine whether the AI model of the base station 110 needs to be updated based on the AI information received from the base station 110, and in a case where it is determined that the AI model of the base station 110 needs to be updated, the UE may transfer AI model-related information scheduled to be transferred later to the base station 110.

According to an embodiment of the disclosure, the AI model information may include at least one piece of the following information: a name of an AI model scheduled to be transferred by the UE, a size of an AI model scheduled to be transferred by the UE, use case requirements for an AI model scheduled to be transferred by the UE, AI support case for an AI model scheduled to be transferred by the UE, case requiring update for an AI model scheduled to be transferred by the UE, vendor information about an AI model scheduled to be transferred by the UE, and AI operation layer information of an AI model scheduled to be transferred by the UE.

In operation s650a, the base station 110 may determine an AI model transfer or delivery option based on the AI model information received from the UE 100.

According to an embodiment of the disclosure, the AI model transfer or delivery option may be any one of Options 1 to 4 described above.

According to an embodiment of the disclosure, the AI model transfer or delivery option that the base station 110 may determine may be an option related to an entity transferring the AI model during handover. For example, the base station 110 may select either an option transferred from the UE 100 to a source base station or an option transferred from the UE 100 to a target base station as the AI model transfer or delivery option.

According to an embodiment of the disclosure, the base station 110 may determine, based on the AI model information, a transfer option considering at least one of, for example, a name of an AI model scheduled to be transferred by the UE, a size of an AI model scheduled to be transferred by the UE, use case requirements for an AI model scheduled to be transferred by the UE, AI support case for an AI model scheduled to be transferred by the UE, case requiring update for an AI model scheduled to be transferred by the UE, vendor information about an AI model scheduled to be transferred by the UE, and AI operation layer information of an AI model scheduled to be transferred by the UE. Here, the transfer option may be an option regarding whether to transfer the AI model and the transfer priority of the AI model.

A case where the base station 110 selects an option to determine the AI model receiving entity as a target base station during handover will be described with reference to FIG. 6B. Here, the base station 110 may be the source base station 200.

Referring to FIG. 6B, in operation s610b, the source base station 200 may transfer a message requesting AI information to the target base station 300.

Here, the message requesting the AI information may be a message requesting at least one of the name of the AI model of the target base station 300, the size of the AI model of the target base station 300, use case requirements for the AI model of the target base station 300, AI support case for the AI model of the target base station 300, case requiring update for the AI model of the target base station 300, vendor information about the AI model of the target base station 300, and AI operation layer information of the AI model of the target base station 300.

In operation s630b, the target base station 300 may transfer AI information to the source base station 200 based on the AI information request received from the source base station 200.

In operation s650b, the source base station 200 may transfer the AI information received from the target base station 300 to the UE 100.

The transfer or delivery of the AI model during handover will be described later in FIGS. 7 to 12.

Referring to FIG. 6A, in operation s670a, the base station 110 may schedule the transfer of the AI model to the UE 100 according to the determined AI model transfer option, and transfer UL grant.

In operation s690a, the UE 100 may transfer or deliver the AI model to the base station 110 based on the allocated UL grant. Thereafter, the base station 110 may update the existing AI model with the received AI model.

According to an embodiment of the disclosure, according to the determined AI model transfer option, the UE 100 may transfer the AI model directly to an external server, or may transfer the AI model directly to the target base station.

With reference to FIGS. 7 to 12 below, operations for managing the transfer or delivery of an AI model during handover according to some embodiments of the disclosure will be described.

FIG. 7 is a diagram illustrating a DL transfer or delivery method of an AI model by a source base station during handover according to an embodiment of the disclosure.

Referring to FIG. 7, in operation s705, the UE 100 may determine whether a handover event trigger condition is satisfied.

In operation s710, the UE 100 may transfer a measurement report to the source base station 200. For example, the UE 100 may transfer a measurement report to the source base station 200 based on a time to trigger (TTT) timer.

In operation s715, the source base station 200 may determine whether to perform handover based on the measurement report received from the UE 100.

In a case where it is determined to perform handover, in operation s720, the source base station 200 may transfer a handover request (HO request) to the target base station 300. Here, the handover request message may be transferred along with the UE's AI information and transmitter indicator, which will be described below. The specific transfer method will be described below.

In operation s725, the source base station 200 may transfer the AI information of the UE previously received from the UE 100 to the target base station 300. Here, the AI information of the UE may be AI information previously transferred from the UE 100 to the source base station 200 by the method disclosed in FIGS. 4A, 4B, 5, 6A, and 6B.

Here, the UE's AI information may be a message including the UE's AI information received by the source base station 200 from the UE 100 for DL transfer of the AI model. Here, the message including the UE's AI information may be a message based on the Xn interface.

According to an embodiment of the disclosure, the source base station 200 may deliver (relay) the AI information of the UE 100 received from the UE 100 to the target base station 300.

The AI information of the UE may include at least one piece of the following information. In the information below, the base station may be either the source base station 200 or the target base station 300.
AI model name: information that may determine whether or not an AI model needs to be transferred depending on whether the AI models of the UE and base station are the same in determining whether to transfer or deliver the AI model from the base station to the UE. For example, in a case where the AI models of the UE and base station are the same for a certain case, it may determine that the transfer of the AI model is unnecessary. For example, here, the AI model name may be the identification (ID) of the AI model and may include updated version information of the AI model.
AI model size: information that may determine whether the base station may transfer an AI model through a radio interface according to a size of the AI model, that is, information that may determine whether the base station may transfer the AI model through RRC signaling. Alternatively, information that may determine whether the UE or base station transfers the AI model through CP or UP according to the size of the AI model.
Use case requirement: information that may allow for the base station to determine the priority of the AI model transfer according to requirements, based on latency sensitivity, or the like.
AI support case: information that may determine that transfer of the AI model is unnecessary in a case where a specific case corresponds to a case in which the AI model is not supported. For example, in a case where the UE supports an AI model for CSI estimation, but the base station connected to the UE does not support the AI model for CSI estimation, transferring the AI model from the UE to the base station may be unnecessary for the corresponding case.
Case requiring update: information that may judge whether update is needed for each case and determine a priority of the transfer or delivery of the AI model, based on information about whether the case requires an update for each entity.
Vendor information: information that may determine the vendor information of the UE or entity and consider the need for AI model transfer from a target base station to the UE or from the UE to the target base station. For example, in a case where the base station is constituted by a plurality of vendors, vender information of the corresponding plurality of vendors.
AI operating layer information: information that may determine a transfer option depending on which layer the corresponding AI model operates at. For example, in a DL transfer case, in Option 1 case, a gNB may directly transfer the AI model to the UE, and in Option 4 case, an external server may directly transfer the AI model to the UE.

In operation s730, the source base station 200 may transfer a transmitter indicator to the target base station 300.

Here, the transmitter indicator may be an indicator indicating whether the entity of DL transfer of the AI model is the target base station 300, or whether the entity of DL transfer of the AI model is the source base station 200.

According to an embodiment of the disclosure, the transmitter indicator may be a 1-bit Xn interface-based message that indicates the transferring entity of the AI model. For example, if 1 bit information is ‘1’, it may mean that the transferring entity of the AI model is the source base station 200, and if 1 bit information is ‘O’, it may mean that the transferring entity of the AI model is the target base station 300.

The 1-bit information of the transmitter indicator may be determined by combining information from one of the following embodiments or at least one following embodiment.
According to an embodiment of the disclosure, the source base station 200 may compare the statuses of the wireless communication links of the source base station 200 and target base station 300 based on the measurement report received from the UE 100, and determine the base station with the better status of the wireless communication link as the transferring entity of the AI model.
According to an embodiment of the disclosure, the source base station 200 may consider the latency sensitivity of the case for the corresponding AI model and, in a case where the corresponding case is sensitive to latency, the transferring entity of the AI model may be determined as the source base station 200. In a case where the transferring entity of the AI model is the source base station 200, the AI model may be delivered to the UE 100 before random access ends.

According to an embodiment of the disclosure, a message including AI information of the UE and message including the transmitter indicator may be transferred from the source base station 200 to the target base station 300 prior to the handover request message, simultaneously with the handover request message, or sequentially with the handover request message. Alternatively, the transmitter indicator and AI information of the UE may be included in the handover request message and transferred from the source base station 200 to the target base station 300. For example, the handover request message may include information for updating the AI model of the UE 100 or target base station 300, such as the transmitter indicator and the AI information of the UE.

According to an embodiment of the disclosure, the handover request message may include the AI information of the UE, and may transfer the message including the transmitter indicator from the source base station 200 to the target base station 300, prior to the handover request message including the AI information of the UE, simultaneously with the handover request message, or sequentially with the handover request message.

According to an embodiment of the disclosure, the handover request message may include the transmitter indicator, and may transfer the message including the AI information of the UE from the source base station 200 to the target base station 300, prior to the handover request message including the transmitter indicator, simultaneously with the handover request message, or sequentially with the handover request message.

According to an embodiment of the disclosure, the transmitter indicator and AI information of the UE may be included in one message and transferred from the source base station 200 to the target base station 300, and may be transferred, prior to the handover request message, simultaneously with the handover request message, or sequentially with the handover request message. Here, the message including the transmitter indicator and AI information of the UE may be an Xn interface-based message.

In operation s735, the target base station 300 may determine an AI model to be transferred to the UE 100 based on the AI information of the UE 100 received from the source base station 200.

According to an embodiment of the disclosure, the target base station 300 may determine the priority of AI model transfer based on the AI information of the UE 100. For example, in a case where there are a plurality of AI models to be transferred to the UE 100, the target base station 300 may determine the transfer priority of the plurality of AI models. In the case of the AI model with a high priority, it may be determined that the source base station 200 transfers the AI model, and in the case of the AI model with a low priority, it may be determined that the target base station 300 transfers the AI model. Alternatively, the source base station 200 may determine to preferentially transfer the AI model with a high priority to the UE 100. Here, latency sensitive information of cases related to the corresponding AI model may be used to determine the priority of AI model transfer.

In operation s740, the target base station 300 may transfer a handover request ACK message to the source base station 200. Here, information for updating the AI model may be transferred prior to the handover request ACK message, together with the handover request ACK message, or sequentially with the handover request ACK message. The information for updating the AI model may be various AI-related information, such as the AI information of the target base station 300 or the AI model of the target base station 300 below.

In operation s745, in a case where the source base station 200 is determined to be the entity to transfer the AI model to the UE 100, the target base station 300 may deliver the AI model to be transferred to the UE 100 to the source base station 200. Here, the delivered AI model may be an AI model determined by the target base station 300 based on the AI information of the UE 100 received from the source base station 200.

According to an embodiment of the disclosure, the AI model may be delivered to the source base station 200 prior to the handover request ACK message, simultaneously with the handover request ACK message, or sequentially with the handover request ACK message. Alternatively, the AI model may be included in the handover request ACK message and delivered to the source base station 200.

In operation s750, the source base station 200 may perform DL scheduling for AI model transfer for the AI model received from the target base station 300. Here, the order of operations for performing scheduling is not necessarily limited to the disclosure and may vary.

In operation s755, the source base station 200 may transfer a handover command (HO command) to the UE 100 to perform handover.

In operation s760, the source base station 200 may transfer the AI model received from the target base station 300 to the UE 100 via a DL.

According to an embodiment of the disclosure, the AI model may be transferred to the UE 100, prior to a handover command, simultaneously or sequentially with the handover command, or may be included in the handover command and transferred to the UE 100.

In operation s765, the sequence number (SN) status may be transferred from the source base station 200 to the target base station 300 through a radio interface.

In operation s770, synchronization and random access may be performed between the UE 100 and the target base station 300.

According to an embodiment of the disclosure, the above-determined AI model may be used in the random access process. For example, the UE 100 may perform CSI compression using the above determined AI model and transfer the resulting CSI report to the target base station 300.

In operation s775, the UE 100 may transfer a handover confirmation (HO confirm) message to the target base station 300 to complete the handover performance.

In operation s780, path switch and bearer modification may be performed between the source base station 200 and the target base station 300. In operation s780, the core network (CN) and source base station 200 are disconnected and a new connection between the core network and the target base station 300 may be created.

In operation s785, the target base station 300 may transfer a handover complete (HO complete) message to the source base station 200.

According to the above-described embodiments of the disclosure, by defining signaling between the UE and the network, efficient operation of the AI model transfer and delivery process between the UE and the network is possible. In addition, by defining signaling between the UE and the base station and the base station and the base station, the effect of enabling efficient operation of transfer and delivery of AI models within limited resources during handover can be provided.

Additionally, according to the above-described embodiments of the disclosure, by exchanging AI information prior to RA and determining the AI model to be transferred or delivered, transfer or delivery of the determined AI model immediately after RA may be possible, and thus, transfer or delivery of the AI model within a limited latency is possible. Alternatively, in the case of high priority, it may be possible to transfer the AI model in advance prior to the RA.

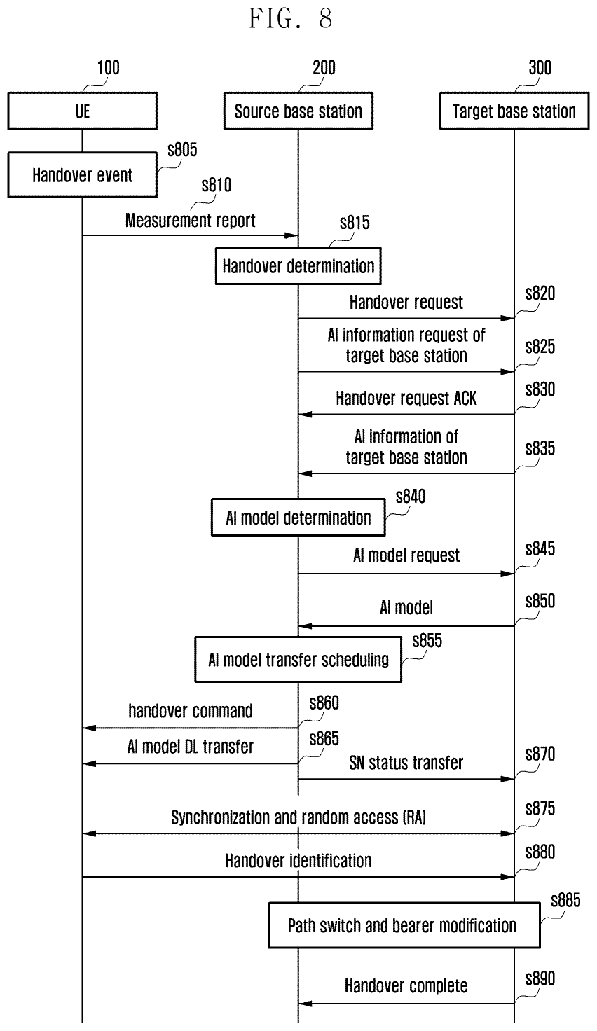

FIG. 8 is a diagram illustrating a DL transfer or delivery method of an AI model by a source base station during handover according to an embodiment of the disclosure.

Referring to FIG. 8, in operation s805, the UE 100 may determine whether a handover event trigger condition is satisfied.

In operation s810, the UE 100 may transfer a measurement report to the source base station 200. For example, the UE 100 may transfer the measurement report to the source base station 200 based on a TTT timer.

In operation s815, the source base station 200 may determine whether to perform handover based on the measurement report received from the UE 100.

In a case where it is determined to perform a handover, in operation s820, the source base station 200 may transfer a handover request (HO request) to the target base station 300. Here, the handover request message may be transferred together with the AI information request message of the target base station 300, which will be described below. The specific transfer method will be described below.

In operation s825, the source base station 200 may transfer an AI information request to the target base station 300. Here, the AI information request may be a request for the AI information of the target base station 300 to determine the AI model required when transferring the AI model of the source base station 200 via a DL. The AI information request may be a message based on an Xn interface.

According to an embodiment of the disclosure, the AI information request may be a message requesting at least one of the name of the AI model of the target base station 300, the size of the AI model of the target base station 300, use case requirements for the AI model of the target base station 300, AI support case for the AI model of the target base station 300, case requiring update for the AI model of the target base station 300, vendor information about the AI model of the target base station 300, and AI operation layer information of the AI model of the target base station 300.

According to an embodiment of the disclosure, the AI information request may be a 1-bit message.

According to an embodiment of the disclosure, the AI information request may be an N-bit message requesting only information (sector) that needs to be updated among the AI information of the target base station 300.

For example, among 1) the name of the AI model of the target base station 300, 2) the size of the AI model of the target base station 300, 3) use case requirements for the AI model of the target base station 300, 4) AI support case for the AI model of the target base station 300, 5) case requiring update for the AI model of the target base station 300, 6) vendor information about the AI model of the target base station 300, and 7) AI operation layer information of the AI model of the target base station 300, in a case where only information 1), 3), and 5) is required, the source base station 200 may include ‘1010100’ bit information in the AI information request message to transfer the same to the target base station 300.

According to an embodiment of the disclosure, the handover request message may include a request for AI information from the target base station 300. Alternatively, the AI information request message of the target base station 300 may be transferred from the source base station 200 to the target base station 300, prior to the handover request message, simultaneously with the handover request message, or sequentially with the handover request message.

In operation s830, the target base station 300 may transfer a handover request ACK message to the source base station 200. Here, information for updating the AI model may be transferred, prior to the handover request ACK message, together with the handover request ACK message, or sequentially with the handover request ACK message. The information for updating the AI model may be various AI-related information, such as the AI information of the target base station 300 or the AI model of the target base station 300 below.

In operation s835, the target base station 300 may transfer the AI information of the target base station 300 to the source base station 200 in response to the AI information request from the source base station 200.

According to an embodiment of the disclosure, in a case where the AI information request message is an N-bit message and the AI information request message includes ‘1010100’ bit information and is transferred, the target base station 300 may only transfer the AI information corresponding to ‘1010100’ bit to the source base station 200. For example, the target base station 300 may transfer, to the source base station 200, only the information about 1) the name of the AI model of the target base station 300, 3) use case requirements for the AI model of the target base station 300, and 5) case requiring update for the AI model of the target base station 300, which correspond to ‘1010100’ bit.

According to an embodiment of the disclosure, the target base station 300 may transfer the AI information of the target base station 300 to the source base station 200, prior to the handover request ACK, simultaneously with the handover request ACK, or sequentially with the handover request ACK. Alternatively, the AI information of the target base station 300 may be included in the handover request ACK and transferred to the source base station 200.

In operation s840, the source base station 200 may determine an AI model to be transferred to the UE 100, based on the AI information of the target base station 300 received from the target base station 300 and the AI information of the UE 100 received from the UE 100.

According to an embodiment of the disclosure, the source base station 200 may determine the priority of AI model transfer, based on the AI information of the UE 100 and the AI information of the target base station 300. For example, in a case where there are a plurality of AI models to be transferred to the UE 100, the source base station 200 may determine the transfer priority of the plurality of AI models, and allow the source base station 200 to transfer in the case of the AI model with high priority, and allow the target base station 300 to transfer in the case of the AI model with a low priority. Alternatively, the source base station 200 may determine to preferentially transfer the AI model with a high priority to the UE 100. Here, latency sensitive information of case related to the corresponding AI model may be used to determine the priority of AI model transfer.

In operation s845, in a case where the source base station 200 is determined to be an entity that will transfer the AI model to the UE 100, the source base station 200 may transfer an AI model request to the target base station 300. Here, the AI model request message may be a message requesting to transfer the AI model of the target base station 300 to the source base station 200 in a case where the AI model of the UE 100 needs to be updated to the AI model of the target base station 300.

In operation s850, the target base station 300 may deliver an AI model to be transferred to the UE 100 to the source base station 200.

In operation s855, the source base station 200 may perform DL scheduling of the AI model received from the target base station 300. Here, the order of operations for performing the scheduling is not necessarily limited to the disclosure and may vary.

In operation s860, the source base station 200 may transfer a handover command to the UE 100 to perform handover.

In operation s865, the source base station 200 may transfer the AI model received from the target base station 300 to the UE 100 via an DL.

According to an embodiment of the disclosure, the AI model may be transferred prior to the handover command, simultaneously with the handover command, or sequentially with the handover command, or may be included in the handover command and transferred to the UE 100.

In operation s870, the source base station 200 may transfer an SN status to the target base station 300 through a radio interface.

In operation s875, synchronization and random access may be performed between the UE 100 and the target base station 300.

According to an embodiment of the disclosure, the above determined AI model may be used in the random access process. For example, the UE 100 may perform CSI compression using the above determined AI model and transfer the resulting CSI report to the target base station 300.

In operation s880, the UE 100 may transfer a handover identification message to the target base station 300 to complete the handover.

In operation s885, path switch and bearer modification may be performed between the source base station 200 and the target base station 300. In operation s885, the core network and source base station 200 are disconnected and a new connection between the core network and the target base station 300 may be created.

In operation s890, the target base station 300 may transfer a handover complete message to the source base station 200.

According to the above-described embodiments of the disclosure, by defining signaling between the UE and the network, efficient operation of the AI model transfer and delivery process between the UE and the network is possible. In addition, by defining signaling between the UE and the base station and the base station and the base station, the effect of enabling efficient operation of transfer and delivery of AI models within limited resources during handover can be provided.

Additionally, according to the above-described embodiments of the disclosure, by exchanging AI information prior to RA and determining the AI model to be transferred or delivered, transfer or delivery of the determined AI model immediately after RA may be possible, and thus, transfer or delivery of the AI model within a limited latency is possible. Alternatively, in the case of high priority, it may be possible to transfer the AI model in advance prior to the RA.

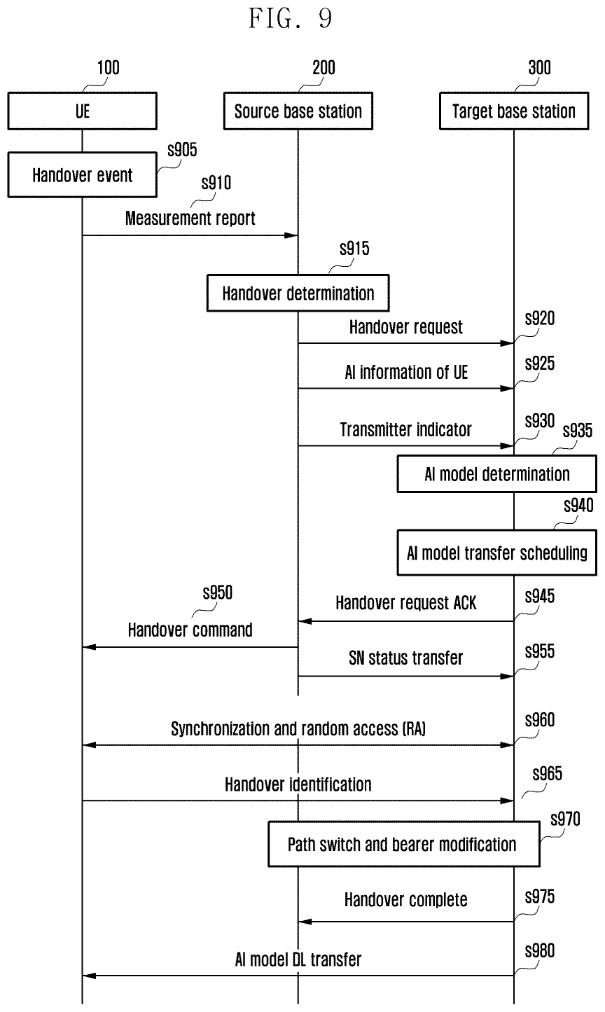

FIG. 9 is a diagram illustrating a DL transfer or delivery method of an AI model by a target base station during handover according to an embodiment of the disclosure.

Referring to FIG. 9, in operation s905, the UE 100 may determine whether a handover event trigger condition is satisfied. In operation s910, the UE 100 may transfer a measurement report to the source base station 200. For example, the UE 100 may transfer the measurement report to the source base station 200 based on a TTT timer.

In operation s915, the source base station 200 may determine whether to perform handover based on the measurement report received from the UE 100.

In a case where it is determined to perform a handover, in operation s920, the source base station 200 may transfer a handover request to the target base station 300. Here, the handover request message may be transferred together with the AI information of the UE and the transmitter indicator, which will be described below. The specific transfer method will be described below.

In operation s925, the source base station 200 may transfer the AI information of the UE received from the UE 100 to the target base station 300. Here, the AI information of the UE may be the AI information previously transferred from the UE 100 to the source base station 200 by the method disclosed in FIGS. 4A, 4B, 5, 6A, and 6B. Here, the AI information of the UE may be a message including the AI information of the UE received by the source base station 200 from the UE 100 for DL transfer of the AI model. Here, the message including the AI information of the UE may be a message based on the Xn interface.

According to an embodiment of the disclosure, the source base station 200 may deliver (relay) the AI information of the UE 100 received from the UE 100 to the target base station 300.

The AI information of the UE may include at least one piece of the following information. In the information below, the base station may be either the source base station 200 or the target base station 300.
AI model name: information that may determine whether or not an AI model needs to be transferred depending on whether the AI models of the UE and base station are the same in determining whether to transfer or deliver the AI model from the base station to the UE. For example, in a case where the AI models of certain cases of the UE and base station are the same, it may determine that the transfer of the AI model is unnecessary. For example, here, the AI model name may be the ID of the AI model and may include updated version information of the AI model.
AI model size: information that may determine whether the base station may transfer an AI model through a radio interface according to a size of the AI model, that is, information that may determine whether the base station may transfer the AI model through RRC signaling or DCI. Alternatively, information that may determine whether the UE or base station transfers the AI model through CP or UP according to the size of the AI model.
Use case requirement: information that may allow for the base station to determine the priority of the AI model transfer according to requirements, based on latency sensitivity, or the like.
AI support case: information that may determine that transfer of the AI model is unnecessary in a case where a specific case corresponds to a case in which the AI model is not supported. For example, in a case where the UE supports an AI model for CSI estimation, but the base station connected to the UE does not support the AI model for CSI estimation, transferring the AI model from the UE to the base station may be unnecessary for the corresponding case.
Case requiring update: information that may judge whether update is needed for each case and determine a priority of the transfer or delivery of the AI model, based on information about whether the case requires an update for each entity.
Vendor information: information that may determine the vendor information of a UE or entity in a handover situation and consider the need for AI model transfer from the target base station to the UE or from the UE to the target base station. For example, in a case where the base station is constituted by a plurality of vendors, vender information of the corresponding plurality of vendors.
AI operating layer information: information that may determine a transfer option depending on which layer the corresponding AI model operates at. For example, in a DL transfer case, in Option 1 case, a gNB may directly transfer the AI model to the UE, and in Option 4 case, an external server may directly transfer the AI model to the UE.

In operation s930, the source base station 200 may transfer a transmitter indicator to the target base station 300.

Here, the transmitter indicator may be an indicator indicating whether the entity of DL transfer of the AI model is the target base station 300, or whether the entity of DL transfer of the AI model is the source base station 200.

According to an embodiment of the disclosure, the transmitter indicator may be a 1-bit Xn interface-based message that indicates the transferring entity of the AI model. For example, if 1 bit information is ‘1’, it may mean that the transferring entity of the AI model is the source base station 200, and if 1 bit information is ‘O’, it may mean that the transferring entity of the AI model is the target base station 300.

The 1-bit information of the transmitter indicator may be determined by combining information from one of the following embodiments or at least one following embodiment.
According to an embodiment of the disclosure, the source base station 200 may compare the statuses of the wireless communication links of the source base station 200 and target base station 300 based on the measurement report received from the UE 100, and determine the base station with the better status of the wireless communication link as the transferring entity of the AI model.
According to an embodiment of the disclosure, the source base station 200 may consider the latency sensitivity of the case for the corresponding AI model and, in a case where the corresponding case is sensitive to latency, the transferring entity of the AI model may be determined as the source base station 200. In a case where the transferring entity of the AI model is the source base station 200, the AI model may be delivered to the target base station 300 before random access ends.

According to an embodiment of the disclosure, a message including AI information of the UE and message including the transmitter indicator may be transferred from the source base station 200 to the target base station 300 prior to the handover request message, simultaneously with the handover request message, or sequentially with the handover request message. Alternatively, the transmitter indicator and AI information of the UE may be included in the handover request message and transferred from the source base station 200 to the target base station 300. For example, the handover request message may include information for updating the AI model of the UE 100 or target base station 300, such as the transmitter indicator and the AI information of the UE.

According to an embodiment of the disclosure, the handover request message may include the AI information of the UE, and may transfer the message including the transmitter indicator from the source base station 200 to the target base station 300, prior to the handover request message including the AI information of the UE, simultaneously with the handover request message, or sequentially with the handover request message.

According to an embodiment of the disclosure, the handover request message may include the transmitter indicator, and may transfer the message including the AI information of the UE from the source base station 200 to the target base station 300, prior to the handover request message including the transmitter indicator, simultaneously with the handover request message, or sequentially with the handover request message.

According to an embodiment of the disclosure, the transmitter indicator and AI information of the UE may be included in one message and transferred from the source base station 200 to the target base station 300, and may be transferred, prior to the handover request message, simultaneously with the handover request message, or sequentially with the handover request message. Here, the message including the transmitter indicator and AI information of the UE may be an Xn interface-based message.

In operation s935, the target base station 300 may determine an AI model to be transferred to the UE 100, based on the AI information of the UE 100 received from the source base station 200 and the AI information of the target base station 300.

According to an embodiment of the disclosure, the target base station 300 may determine the priority of AI model transfer based on the AI information of the UE 100. For example, in a case where there are a plurality of AI models to be transferred to the UE 100, the target base station 300 may determine the transfer priority of the plurality of AI models. In the case of the AI model with a high priority, it may be determined that the source base station 200 transfers the AI model, and in the case of the AI model with a low priority, it may be determined that the target base station 300 transfers the AI model. Alternatively, the source base station 200 may determine to preferentially transfer the AI model with a high priority to the UE 100. Here, latency sensitive information of cases related to the corresponding AI model may be used to determine the priority of AI model transfer.

In operation s940, the target base station 300 may perform DL scheduling for AI model transfer in relation to the AI model determined to be transferred to the UE 100. Here, the order of operations for performing the scheduling is not necessarily limited to the disclosure and may vary.

In operation s945, the target base station 300 may transfer a handover request ACK message to the source base station 200.

In operation s950, the source base station 200 may transfer a handover command to the UE 100 to perform handover.

In operation s955, the SN status may be transferred from the source base station 200 to the target base station 300 through a radio interface.

In operation s960, synchronization and random access may be performed between the UE 100 and the target base station 300.

In operation s965, the UE 100 may transfer a handover identification message to the target base station 300 to complete the handover.

In operation s970, path switch and bearer modification may be performed between the source base station 200 and the target base station 300. For example, the core network (CN) and source base station 200 are disconnected and a new connection between the core network and the target base station 300 may be created.

In operation s975, the target base station 300 may transfer a handover complete message to the source base station 200.

In operation s980, the target base station 300 may transfer, to the UE 100, the AI model determined to be transferred to the UE 100 via a DL.

According to the above-described embodiment of the disclosure, in a case where the radio link of the target base station is better than that of the source base station and the latency sensitivity of the corresponding case is low, the transfer and delivery of the AI model may be efficiently operated by transferring the AI model to the UE 100 after completion of handover for the corresponding case.

According to the above-described embodiments of the disclosure, by defining signaling between the UE and the network, efficient operation of the AI model transfer and delivery process between the UE and the network is possible. In addition, by defining signaling between the UE and the base station and the base station and the base station, the effect of enabling efficient operation of transfer and delivery of AI models within limited resources during handover can be provided.

Additionally, according to the above-described embodiments of the disclosure, by exchanging AI information prior to RA and determining the AI model to be transferred or delivered, transfer or delivery of the determined AI model immediately after RA may be possible, and thus, transfer or delivery of the AI model within a limited latency is possible. Alternatively, in the case of high priority, it may be possible to transfer the AI model in advance prior to the RA.

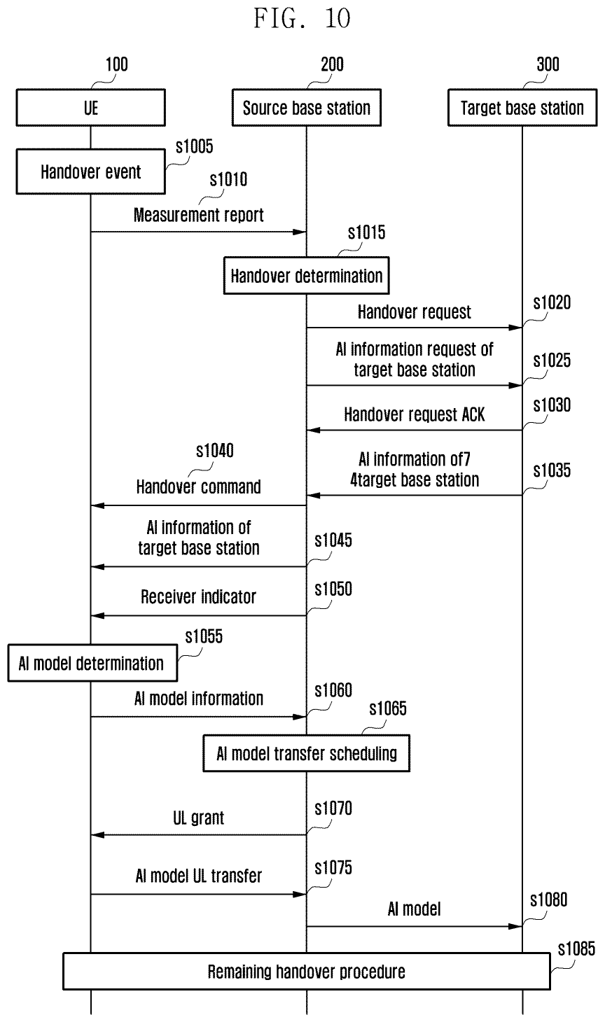

FIG. 10 is a diagram illustrating a UL transfer or delivery method of an AI model by a UE during handover according to an embodiment of the disclosure.

Referring to FIG. 10, in operation s1005, the UE 100 may determine whether a handover event trigger condition is satisfied.

In operation s1010, the UE 100 may transfer a measurement report to the source base station 200. For example, the UE 100 may transfer the measurement report to the source base station 200 based on a TTT timer.

In operation s1015, the source base station 200 may determine whether to perform handover based on the measurement report received from the UE 100.

In a case where it is determined to perform a handover, in operation s1020, the source base station 200 may transfer a handover request to the target base station 300. Here, the handover request message may be transferred together with the AI information request message of the target base station 300, which will be described below. The specific transfer method will be described below.

In operation s1025, the source base station 200 may transfer an AI information request to the target base station 300. Here, the AI information request may be a request for the AI information of the target base station 300 to determine the AI model required when the UE 100 transfers the AI model to the target base station 300 via an UL. The AI information request may be a message based on an Xn interface.

According to an embodiment of the disclosure, the AI information request may be a message requesting at least one of the name of the AI model of the target base station 300, the size of the AI model of the target base station 300, use case requirements for the AI model of the target base station 300, AI support case for the AI model of the target base station 300, case requiring update for the AI model of the target base station 300, vendor information about the AI model of the target base station 300, and AI operation layer information of the AI model of the target base station 300.

According to an embodiment of the disclosure, the AI information request may be a 1-bit message.

According to an embodiment of the disclosure, the AI information request may be an N-bit message requesting only some pieces of information (sector) among the AI information of the target base station 300.

For example, among 1) the name of the AI model of the target base station 300, 2) the size of the AI model of the target base station 300, 3) use case requirements for the AI model of the target base station 300, 4) AI support case for the AI model of the target base station 300, 5) case requiring update for the AI model of the target base station 300, 6) vendor information about the AI model of the target base station 300, and 7) AI operation layer information of the AI model of the target base station 300, in a case where only information 1), 3), and 5) is requested, the source base station 200 may include ‘1010100’ bit information in the AI information request message to transfer the same to the target base station 300.

According to an embodiment of the disclosure, the handover request message may include a request for AI information from the target base station 300. Alternatively, the AI information request message of the target base station 300 may be transferred from the source base station 200 to the target base station 300, prior to the handover request message, simultaneously with the handover request message, or sequentially with the handover request message.

In operation s1030, the target base station 300 may transfer a handover request ACK message to the source base station 200. Here, information for updating the AI model may be transferred, prior to the handover request ACK message, together with the handover request ACK message, or sequentially with the handover request ACK message. The information for updating the AI model may be various AI-related information, such as the AI information of the target base station 300 or the AI model of the target base station 300 below.

In operation s1035, the target base station 300 may transfer the AI information of the target base station 300 to the source base station 200 in response to the AI information request from the source base station 200.

According to an embodiment of the disclosure, in a case where the AI information request message is an N-bit message and the AI information request message includes ‘1010100’ bit information and is transferred, the target base station 300 may only transfer the AI information corresponding to ‘1010100’ bit to the source base station 200. For example, the target base station 300 may transfer, to the source base station 200, only the information about 1) the name of the AI model of the target base station 300, 3) use case requirements for the AI model of the target base station 300, and 5) case requiring update for the AI model of the target base station 300, which correspond to ‘1010100’ bit.

According to an embodiment of the disclosure, the target base station 300 may transfer the AI information of the target base station 300 to the source base station 200, prior to the handover request ACK, simultaneously with the handover request ACK, or sequentially with the handover request ACK. Alternatively, the AI information of the target base station 300 may be included in the handover request ACK and transferred to the source base station 200.

In operation s1040, the source base station 200 may transfer a handover command to the UE 100 to perform handover. Here, the handover command may be transferred along with the AI information of the target base station and a receiver indicator, which will be described below. The specific transfer method will be described below.

In operation s1045, the source base station 200 may transfer the AI information of the target base station received from the target base station 300 to the UE 100.

According to an embodiment of the disclosure, the source base station 200 may deliver (relay) the AI information of the target base station 300 received from the target base station 300 to the UE 100.

In operation s1050, the source base station 200 may transfer a receiver indicator to the UE 100.

Here, the receiver indicator may be an indicator indicating whether the receiving entity of the UL transfer of the AI model is the target base station 300, or whether the receiving entity of the UL transfer of the AI model is the source base station 200. For example, in a case where the receiving entity of the UL transfer of the AI model is the source base station 200, the source base station 200 becomes a first receiver, the target base station 300 becomes a second receiver, and thus, the source base station 200 may deliver the AI model to the target base station 300, which is the second receiver.

According to an embodiment of the disclosure, the receiver indicator may be a 1-bit message that indicates the receiving entity of the AI model. For example, if 1 bit information is ‘1’, it may mean that the receiving entity of the AI model is the source base station 200, and if 1 bit information is ‘0’, it may mean that the receiving entity of the AI model is the target base station 300.

The 1-bit information of the receiver indicator may be determined by combining information from one of the following embodiments or at least one following embodiment.
According to an embodiment of the disclosure, the source base station 200 may compare the statuses of the wireless communication links of the source base station 200 and target base station 300 based on the measurement report received from the UE 100, and determine the base station with the better status of the wireless communication link as the receiving entity of the AI model.
According to an embodiment of the disclosure, the source base station 200 may consider the latency sensitivity of the case for the corresponding AI model and, in a case where the corresponding case is sensitive to latency, the receiving entity of the AI model may be determined as the source base station 200. In a case where the receiving entity of the AI model is the source base station 200, the AI model may be delivered to the target base station 300 before random access ends.

According to an embodiment of the disclosure, a message including AI information of the target base station 300 and message including the receiver indicator may be transferred from the source base station 200 to the UE 100 prior to the handover command, simultaneously with the handover command, or sequentially with the handover command. Alternatively, the receiver indicator and AI information of the target base station 300 may be included in the handover command and transferred from the source base station 200 to the UE 100.

According to an embodiment of the disclosure, the handover command may include the AI information of the target base station, and may transfer the message including the receiver indicator from the source base station 200 to the UE 100, prior to the handover command including the AI information of the target base station, simultaneously with the handover command, or sequentially with the handover command.

According to an embodiment of the disclosure, the handover command may include the receiver indicator, and may transfer the message including the AI information of the target base station from the source base station 200 to the UE 100, prior to the handover command including the receiver indicator, simultaneously with the handover command, or sequentially with the handover command.

According to an embodiment of the disclosure, the receiver indicator and AI information of the target base station may be included in one message and transferred from the source base station 200 to the UE 100, and may be transferred, prior to the handover command, simultaneously with the handover command, or sequentially with the handover command. Here, the message including the receiver indicator and AI information of the target base station may be an RRC signaling message.

In operation s1055, the UE 100 may determine an AI model to be transferred to the target base station 300, based on the AI information of the target base station 300 received from the source base station 200 and the AI information of the UE 100.

According to an embodiment of the disclosure, the UE 100 may determine the priority of AI model transfer, based on the AI information of the UE 100 and the AI information of the target base station 300. For example, in a case where there are a plurality of AI models to be transferred to the target base station 300, the UE 100 may determine the transfer priority of the plurality of AI models, and allow the source base station 200 to receive in the case of the AI model with high priority, and allow the target base station 300 to receive directly in the case of the AI model with a low priority. In a case where the source base station 200 receives the AI model from the UE 100, the source base station 200 may transfer the received AI model to the target base station 300. Alternatively, the source base station 200 may determine to preferentially transfer the AI model with a high priority to the target base station 300. Here, latency sensitive information of case related to the corresponding AI model may be used to determine the priority of AI model transfer.

In operation s1060, the source base station 200 may receive, from the UE 100, the AI model information scheduled to be transferred by the UE 100.

Hereinafter, in a case where the UE 100 determines an AI model that performs UL transfer to the source base station 200, the AI model information may be information including the type of option for transferring or delivering the corresponding AI model, the priority of the AI model, scheduling information, or the like. Hereinafter, the AI model information may include at least one piece of the following information.
A name of an AI model scheduled to be transferred by the UE,
A size of an AI model scheduled to be transferred by the UE,
Use case requirements for an AI model scheduled to be transferred by the UE,
AI support case for an AI model scheduled to be transferred by the UE,
Case requiring update for an AI model scheduled to be transferred by the UE,
Vendor information about an AI model scheduled to be transferred by the UE, and
AI operation layer information of an AI model scheduled to be transferred by the UE

In operation s1065, the source base station 200 may perform scheduling for UL transfer of the AI model from the UE 100 to the source base station 200, based on the AI model information scheduled to be transferred by the UE 100 received from the UE 100.

According to an embodiment of the disclosure, the source base station 200 may determine an AI model transfer option and an AI model transfer priority, and perform scheduling for UL transfer of the AI model from the UE 100 to the source base station 200, based on the above determined AI model transfer option and/or AI model transfer priority.

In operation s1070, the source base station 200 may transfer an UL grant to the UE 100 by scheduling UL transfer of the determined AI model.

In operation s1075, the UE 100 may transfer the AI model to the source base station 200 based on the allocated UL grant.

In operation s1080, the source base station 200 may deliver the AI model received from the UE to the target base station 300. Thereafter, the target base station 300 may update the existing AI model with the received AI model.

Thereafter, in operation s1085, the remaining handover procedure may be performed.

According to an embodiment of the disclosure, the above determined AI model may be used in a random access process during a handover procedure. For example, the target base station 300 may decompress the CSI received from the UE 100 using the above determined AI model.

According to the above-described embodiments of the disclosure, by defining signaling between the UE and the network, efficient operation of the AI model transfer and delivery process between the UE and the network is possible. In addition, by defining signaling between the UE and the base station and the base station and the base station, the effect of enabling efficient operation of transfer and delivery of AI models within limited resources during handover can be provided.

Additionally, according to the above-described embodiments of the disclosure, by exchanging AI information prior to RA and determining the AI model to be transferred or delivered, transfer or delivery of the determined AI model immediately after RA may be possible, and thus, transfer or delivery of the AI model within a limited latency is possible. Alternatively, in the case of high priority, it may be possible to transfer the AI model in advance prior to the RA.

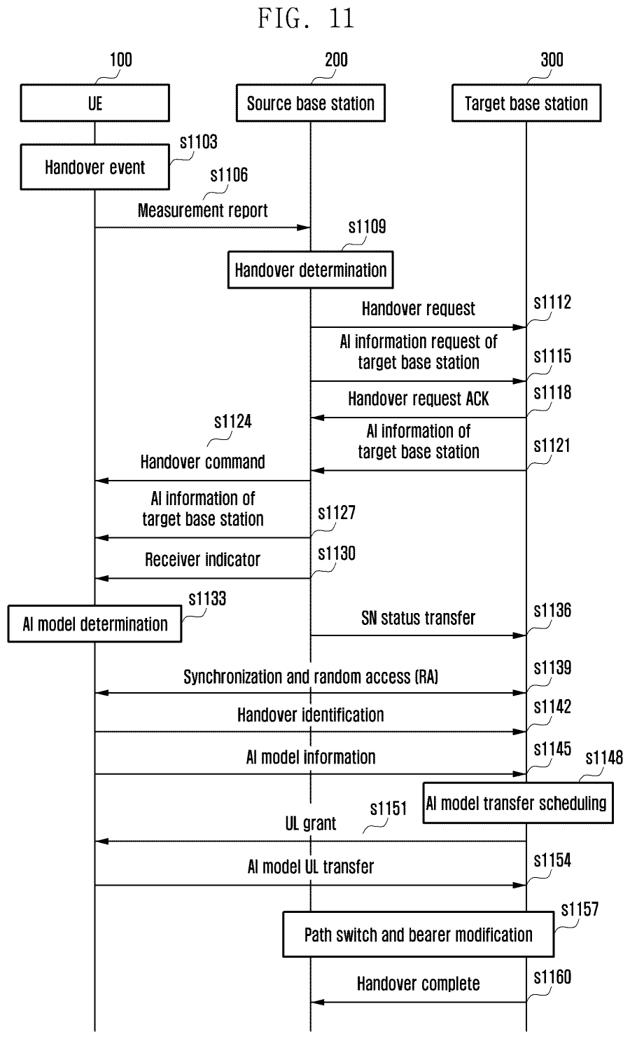

FIG. 11 is a diagram illustrating a UL transfer or delivery method of an AI model by a UE during handover according to an embodiment of the disclosure.

Referring to FIG. 11, in operation s1103, the UE 100 may determine whether a handover event trigger condition is satisfied.

In operation s1106, the UE 100 may transfer a measurement report to the source base station 200. For example, the UE 100 may transfer the measurement report to the source base station 200 based on a TTT timer.

In operation s1109, the source base station 200 may determine whether to perform handover based on the measurement report received from the UE 100.

In a case where it is determined to perform a handover, in operation s1112, the source base station 200 may transfer a handover request to the target base station 300. Here, the handover request message may be transferred together with the AI information request message of the target base station 300, which will be described below. The specific transfer method will be described below.

In operation s1115, the source base station 200 may transfer an AI information request to the target base station 300. Here, the AI information request may be a request for the AI information of the target base station 300 to determine the AI model required when the UE 100 transfers the AI model to the target base station 300 via an UL. The AI information request may be a message based on an Xn interface.

According to an embodiment of the disclosure, the AI information request may be a message requesting at least one of the name of the AI model of the target base station 300, the size of the AI model of the target base station 300, use case requirements for the AI model of the target base station 300, AI support case for the AI model of the target base station 300, case requiring update for the AI model of the target base station 300, vendor information about the AI model of the target base station 300, and AI operation layer information of the AI model of the target base station 300.

According to an embodiment of the disclosure, the AI information request may be a 1-bit message.

According to an embodiment of the disclosure, the AI information request may be an N-bit message requesting only some pieces of information (sector) among the AI information of the target base station 300.

For example, among 1) the name of the AI model of the target base station 300, 2) the size of the AI model of the target base station 300, 3) use case requirements for the AI model of the target base station 300, 4) AI support case for the AI model of the target base station 300, 5) case requiring update for the AI model of the target base station 300, 6) vendor information about the AI model of the target base station 300, and 7) AI operation layer information of the AI model of the target base station 300, in a case where only information 1), 3), and 5) is requested, the source base station 200 may include ‘1010100’ bit information in the AI information request message to transfer the same to the target base station 300.

According to an embodiment of the disclosure, the handover request message may include a request for AI information from the target base station 300. Alternatively, the AI information request message of the target base station 300 may be transferred from the source base station 200 to the target base station 300, prior to the handover request message, simultaneously with the handover request message, or sequentially with the handover request message.

In operation s1118, the target base station 300 may transfer a handover request ACK message to the source base station 200.

In operation s1121, the target base station 300 may transfer the AI information of the target base station 300 to the source base station 200, in response to the AI information request of the source base station 200. Here, information for updating the AI model may be transferred prior to the handover request ACK message, together with the handover request ACK message, or sequentially with the handover request ACK message. The information for updating the AI model may be various AI-related information, such as the AI information of the target base station 300 or the AI model of the target base station 300 below.

According to an embodiment of the disclosure, in a case where the AI information request message is an N-bit message and the AI information request message includes ‘1010100’ bit information and is transferred, the target base station 300 may only transfer the AI information corresponding to ‘1010100’ bit to the source base station 200. For example, the target base station 300 may transfer, to the source base station 200, only the information about 1) the name of the AI model of the target base station 300, 3) use case requirements for the AI model of the target base station 300, and 5) case requiring update for the AI model of the target base station 300, which correspond to ‘1010100’ bit.

According to an embodiment of the disclosure, the target base station 300 may transfer the AI information of the target base station 300 to the source base station 200, prior to the handover request ACK, simultaneously with the handover request ACK, or sequentially with the handover request ACK. Alternatively, the AI information of the target base station 300 may be included in the handover request ACK and transferred to the source base station 200.

In operation s1124, the source base station 200 may transfer a handover command to the UE 100 to perform handover. Here, the handover command may be transferred along with the AI information of the target base station and receiver indicator, which will be described below. The specific transfer method will be described below.

In operation s1127, the source base station 200 may transfer the AI information of the target base station received from the target base station 300 to the UE 100.

According to an embodiment of the disclosure, the source base station 200 may deliver (relay) the AI information of the target base station 300 received from the target base station 300 to the UE 100.

In operation s1130, the source base station 200 may transfer a receiver indicator to the UE 100.

Here, the receiver indicator may be an indicator indicating whether the receiving entity of the UL transfer of the AI model is the target base station 300, or whether the receiving entity of the UL transfer of the AI model is the source base station 200. For example, in a case where the receiving entity of the UL transfer of the AI model is the source base station 200, the source base station 200 becomes a first receiver, the target base station 300 becomes a second receiver, and thus, the source base station 200 may deliver the AI model to the target base station 300, which is the second receiver.

According to an embodiment of the disclosure, the receiver indicator may be a 1-bit message that indicates the receiving entity of the AI model. For example, if 1 bit information is ‘1’, it may mean that the receiving entity of the AI model is the source base station 200, and if 1 bit information is ‘0’, it may mean that the receiving entity of the AI model is the target base station 300.

The 1-bit information of the receiver indicator may be determined by combining information from one of the following embodiments or at least one following embodiment.
According to an embodiment of the disclosure, the source base station 200 may compare the statuses of the wireless communication links of the source base station 200 and target base station 300 based on the measurement report received from the UE 100, and determine the base station with the better status of the wireless communication link as the receiving entity of the AI model.
According to an embodiment of the disclosure, the source base station 200 may consider the latency sensitivity of the case for the corresponding AI model and, in a case where the corresponding case is sensitive to latency, the receiving entity of the AI model may be determined as the source base station 200. In a case where the receiving entity of the AI model is the source base station 200, the AI model may be delivered to the target base station 300 before random access ends.

According to an embodiment of the disclosure, a message including the AI information of the target base station 300 and message including the receiver indicator may be transferred from the source base station 200 to the UE 100, prior to the handover command, simultaneously with the handover command, or sequentially with the handover command. Alternatively, the receiver indicator and AI information of the target base station 300 may be included in the handover command and transferred from the source base station 200 to the UE 100.

According to an embodiment of the disclosure, the handover command may include the AI information of the target base station, and may transfer the message including the receiver indicator from the source base station 200 to the UE 100, prior to the handover command including the AI information of the target base station, simultaneously with the handover command, or sequentially with the handover command.

According to an embodiment of the disclosure, the handover command may include the receiver indicator, and may transfer the message including the AI information of the target base station from the source base station 200 to the UE 100, prior to the handover command including the receiver indicator, simultaneously with the handover command, or sequentially with the handover command.

According to an embodiment of the disclosure, the receiver indicator and AI information of the target base station may be included in one message and transferred from the source base station 200 to the UE 100, and may be transferred, prior to the handover command, simultaneously with the handover command, or sequentially with the handover command. Here, the message including the receiver indicator and AI information of the target base station may be an RRC signaling message.

In operation s1133, the UE 100 may determine an AI model to be transferred directly by the UE 100 to the target base station 300, based on the AI information of the target base station 300 received from the source base station 200 and the AI information of the UE 100.

According to an embodiment of the disclosure, the UE 100 may determine the priority of AI model transfer, based on the AI information of the UE 100 and the AI information of the target base station 300. For example, in a case where there are a plurality of AI models to be transferred to the target base station 300, the UE 100 may determine the transfer priority of the plurality of AI models, and allow the source base station 200 to receive in the case of the AI model with high priority, and allow the target base station 300 to receive directly in the case of the AI model with a low priority. In a case where the source base station 200 receives the AI model from the UE 100, the source base station 200 may deliver the received AI model to the target base station 300. Alternatively, the source base station 200 may determine to preferentially transfer the AI model with a high priority to the target base station 300. Here, latency sensitive information of case related to the corresponding AI model may be used to determine the priority of AI model transfer.

In operation s1136, the source base station 200 may transfer an SN status to the target base station 300 through a radio interface.

In operation s1139, synchronization and random access may be performed between the UE 100 and the target base station 300.

In operation s1142, the UE 100 may transfer a handover identification message to the target base station 300 to complete the handover performance.

In a case where the target base station 300 is determined to be the receiving entity of the AI model, in operation s1145, the target base station 300 may receive the AI model information scheduled to be transferred by the UE 100 from the UE 100.

Hereinafter, in a case where the UE 100 determines an AI model that performs UL transfer to the target base station 300, the AI model information may be information including the type of option for transferring or delivering the corresponding AI model, the priority of the AI model, scheduling information, or the like.

Hereinafter, the AI model information may include at least one piece of the following information.
A name of an AI model scheduled to be transferred by the UE,
A size of an AI model scheduled to be transferred by the UE,
Use case requirements for an AI model scheduled to be transferred by the UE,
AI support case for an AI model scheduled to be transferred by the UE,
Case requiring update for an AI model scheduled to be transferred by the UE,
Vendor information about an AI model scheduled to be transferred by the UE, and
AI operation layer information of an AI model scheduled to be transferred by the UE

In operation s1148, the target base station 300 may perform scheduling for UL transfer of the AI model from the UE 100 to the target base station 300, based on the AI model information scheduled to be transferred by the UE 100 received from the UE 100.

According to an embodiment of the disclosure, the target base station 300 may determine an AI model transfer option and an AI model transfer priority, and perform scheduling for UL transfer of the AI model from the UE 100 to the target base station 300, based on the above-determined AI model transfer option and/or AI model transfer priority.

In operation s1151, the target base station 300 may transfer an UL grant to the UE 100 by scheduling UL transfer of the determined AI model.

In operation s1154, the UE 100 may transfer the AI model to the target base station 300 based on the allocated UL grant.

In operation s1157, path switch and bearer modification may be performed between the source base station 200 and the target base station 300. For example, the core network (CN) and source base station 200 are disconnected and a new connection between the core network and the target base station 300 may be created.

In operation s1160, the target base station 300 may transfer a handover complete message to the source base station 200.

According to the above-described embodiments of the disclosure, by defining signaling between the UE and the network, efficient operation of the AI model transfer and delivery process between the UE and the network is possible. In addition, by defining signaling between the UE and the base station and the base station and the base station, the effect of enabling efficient operation of transfer and delivery of AI models within limited resources during handover can be provided.

Additionally, according to the above-described embodiments of the disclosure, by exchanging AI information prior to RA and determining the AI model to be transferred or delivered, transfer or delivery of the determined AI model immediately after RA may be possible, and thus, transfer or delivery of the AI model within a limited latency is possible. Alternatively, in the case of high priority, it may be possible to transfer the AI model in advance prior to the RA.

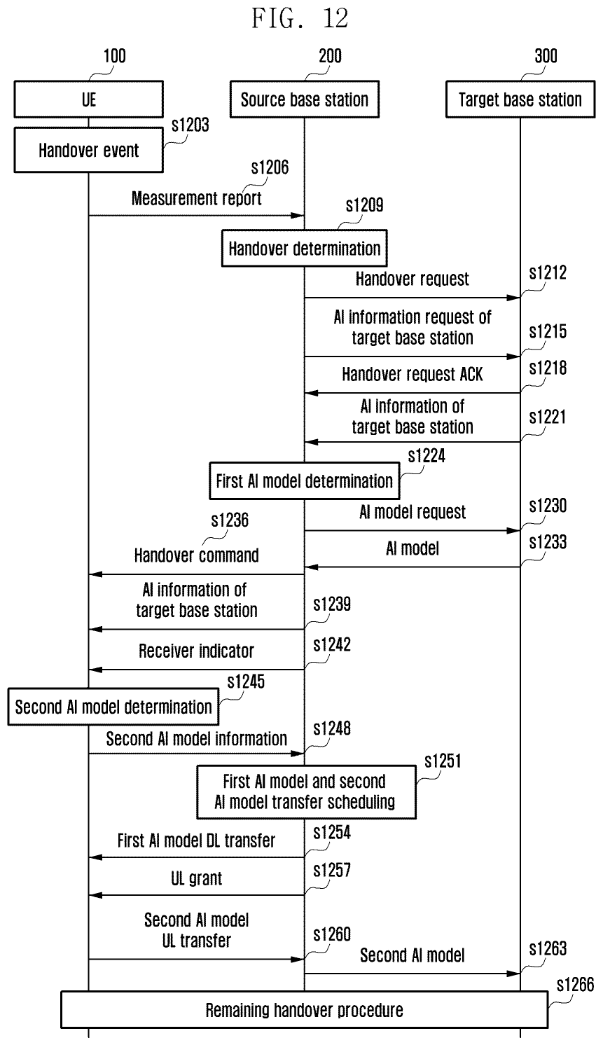

FIG. 12 is a diagram illustrating a UL transfer or delivery and DL transfer or delivery method of an AI model during handover according to an embodiment of the disclosure. Hereinafter, in FIG. 12, the AI model transferred via a DL may be referred to as a DL AI model, and the AI model transferred via an UL may be referred to as an UL AI model.

Referring to FIG. 12, in operation s1203, the UE 100 may determine whether a handover event trigger condition is satisfied.

In operation s1206, the UE 100 may transfer a measurement report to the source base station 200. For example, the UE 100 may transfer the measurement report to the source base station 200 based on a TTT timer.

In operation s1209, the source base station 200 may determine whether to perform handover based on the measurement report received from the UE 100.

In a case where it is determined to perform a handover, in operation s1212, the source base station 200 may transfer a handover request to the target base station 300. Here, the handover request message may be transferred together with the AI information request message of the target base station 300, which will be described below. The specific transfer method will be described below.

In operation s1215, the source base station 200 may transfer an AI information request to the target base station 300. Here, the AI information request may be a request for the AI information of the target base station 300 to determine the AI model required when the UE 100 transfers the AI model to the target base station 300 via an UL. The AI information request may be a message based on an Xn interface.

According to an embodiment of the disclosure, the AI information request may be a message requesting at least one of the name of the AI model of the target base station 300, the size of the AI model of the target base station 300, use case requirements for the AI model of the target base station 300, AI support case for the AI model of the target base station 300, case requiring update for the AI model of the target base station 300, vendor information about the AI model of the target base station 300, and AI operation layer information of the AI model of the target base station 300.

According to an embodiment of the disclosure, the AI information request may be a 1-bit message.

According to an embodiment of the disclosure, the AI information request may be an N-bit message requesting only some pieces of information (sector) among the AI information of the target base station 300.

For example, among 1) the name of the AI model of the target base station 300, 2) the size of the AI model of the target base station 300, 3) use case requirements for the AI model of the target base station 300, 4) AI support case for the AI model of the target base station 300, 5) case requiring update for the AI model of the target base station 300, 6) vendor information about the AI model of the target base station 300, and 7) AI operation layer information of the AI model of the target base station 300, in a case where only information 1), 3), and 5) is requested, the source base station 200 may include ‘1010100’ bit information in the AI information request message to transfer the same to the target base station 300.

According to an embodiment of the disclosure, the source base station 200 may transfer the AI information request to the target base station 300, prior to the handover request, simultaneously with the handover request or sequentially with the handover request. Alternatively, the source base station 200 may include the AI information request of the target base station 300 in the handover request to transfer the same to the target base station 300.

In operation s1218, the target base station 300 may transfer a handover request ACK message to the source base station 200.

In operation s1221, the target base station 300 may transfer the AI information of the target base station 300 to the source base station 200, in response to the AI information request of the source base station 200. Here, information for updating the AI model may be transferred prior to the handover request ACK message, together with the handover request ACK message, or sequentially with the handover request ACK message. The information for updating the AI model may be various AI-related information, such as the AI information of the target base station 300 or the AI model of the target base station 300 below.

According to an embodiment of the disclosure, in a case where the AI information request message is an N-bit message and the AI information request message includes ‘1010100’ bit information and is transferred from the source base station 200 to the target base station 300, the target base station 300 may only transfer the AI information corresponding to ‘1010100’ bit of the AI information request to the source base station 200. For example, the target base station 300 may transfer, to the source base station 200, only the information about 1) the name of the AI model of the target base station 300, 3) use case requirements for the AI model of the target base station 300, and 5) case requiring update for the AI model of the target base station 300, which correspond to ‘1010100’ bit.

According to an embodiment of the disclosure, the target base station 300 may transfer the AI information of the target base station 300 to the source base station 200, prior to the handover request ACK, simultaneously with the handover request ACK, or sequentially with the handover request ACK. Alternatively, the AI information of the target base station 300 may be included in the handover request ACK and transferred to the source base station 200.

In operation s1224, the source base station 200 may determine an AI model to be transferred to the UE 100, based on the AI information of the target base station 300 received from the target base station 300 and the AI information of the UE 100 received from the UE 100.

According to an embodiment of the disclosure, the source base station 200 may determine the priority of AI model transfer based on the AI information of the UE 100 and the AI information of the target base station 300. For example, in a case where there are a plurality of DL AI models to be transferred to the UE 100, the source base station 200 may determine the transfer priority of the plurality of DL AI models. In the case of the DL AI model with a high priority, it may be determined that the source base station 200 transfers the AI model, and in the case of the DL AI model with a low priority, it may be determined that the target base station 300 transfers the AI model. Alternatively, the source base station 200 may determine to preferentially transfer the DL AI model with a high priority to the UE 100. Here, latency sensitive information of cases related to the corresponding AI model may be used to determine the priority of DL AI model transfer.

According to an embodiment of the disclosure, the source base station 200 may determine an AI model for DL transfer and an AI model for UL transfer, based on the AI information of the UE 100 and the AI information of the target base station 300. For example, in a first case, the AI model of the target base station 300 may need to be updated, and in a second case, the AI model of the UE 100 may need to be updated. In this case, in the first case, the source base station 200 may determine the AI model for the first case of the UE 100 as an UL AI model, and in the second case, the source base station 200 may determine the AI model for the second case of the target base station 300 as an DL AI model.

In operation s1230, for DL transfer, in a case where the source base station 200 is determined to be the entity to transfer the AI model to the UE 100, the source base station 200 may transfer an AI model request to the target base station 300. Here, the AI model request message may be a message requesting to transfer the AI model of the target base station 300 to the source base station 200 in a case where the AI model of the UE 100 needs to be updated to the AI model of the target base station 300.

In operation s1233, the target base station 300 may deliver the AI model to be transferred to the UE 100 to the source base station 200.

In operation s1236, the source base station 200 may transfer a handover command to the UE 100 to perform handover. Here, the handover command may be transferred along with the AI information of the target base station and receiver indicator, which will be explained below. The specific transmission method will be described below.

In operation s1239, the source base station 200 may transfer the AI information of the target base station 300 received from the target base station 300 to the UE 100.

According to an embodiment of the disclosure, the source base station 200 may deliver (relay) the AI information of the target base station 300 received from the target base station 300 to the UE 100.

In operation s1242, the source base station 200 may transfer a receiver indicator to the UE 100.

Here, the receiver indicator may be an indicator indicating whether the receiving entity of the UL transfer of the AI model is the target base station 300, or whether the receiving entity of the UL transfer of the AI model is the source base station 200. For example, in a case where the receiving entity of the UL transfer of the AI model is the source base station 200, the source base station 200 becomes a first receiver, the target base station 300 becomes a second receiver, and thus, the source base station 200 may deliver the AI model to the target base station 300, which is the second receiver.

According to an embodiment of the disclosure, the receiver indicator may be a 1-bit message that indicates the receiving entity of the AI model. For example, if 1 bit information is ‘1’, it may mean that the receiving entity of the AI model is the source base station 200, and if 1 bit information is ‘0’, it may mean that the receiving entity of the AI model is the target base station 300.

The 1-bit information of the receiver indicator may be determined by combining information from one of the following embodiments or at least one following embodiment.
According to an embodiment of the disclosure, the source base station 200 may compare the statuses of the wireless communication links of the source base station 200 and target base station 300 based on the measurement report received from the UE 100, and determine the base station with the better status of the wireless communication link as the receiving entity of the AI model.
According to an embodiment of the disclosure, the source base station 200 may consider the latency sensitivity of the case for the corresponding AI model and, in a case where the corresponding case is sensitive to latency, the receiving entity of the AI model may be determined as the source base station 200. In a case where the receiving entity of the AI model is the source base station 200, the AI model may be delivered to the target base station 300 before random access ends.

For example, the source base station 200 comprehensively considers the wireless communication link status of the source base station 200 and target base station 300 and the latency sensitivity of the case for the corresponding AI model to determine the receiving entity of the corresponding AI model, and then, transfer the receiver indicator to the UE 100.

According to an embodiment of the disclosure, a message including the AI information of the target base station 300 and message including the receiver indicator may be transferred from the source base station 200 to the UE 100, prior to the handover command, simultaneously with the handover command, or sequentially with the handover command. Alternatively, the receiver indicator and AI information of the target base station 300 may be included in the handover command and transferred from the source base station 200 to the UE 100.

According to an embodiment of the disclosure, the handover command may include the AI information of the target base station, and may transfer the message including the receiver indicator from the source base station 200 to the UE 100, prior to the handover command including the AI information of the target base station, simultaneously with the handover command, or sequentially with the handover command.

According to an embodiment of the disclosure, the handover command may include the receiver indicator, and may transfer the message including the AI information of the target base station from the source base station 200 to the UE 100, prior to the handover command including the receiver indicator, simultaneously with the handover command, or sequentially with the handover command.

According to an embodiment of the disclosure, the receiver indicator and AI information of the target base station may be included in one message and transferred from the source base station 200 to the UE 100, and may be transferred, prior to the handover command, simultaneously with the handover command, or sequentially with the handover command. Here, the message including the receiver indicator and AI information of the target base station may be an RRC signaling message.

In operation s1245, the UE 100 may determine an AI model to be transferred to the target base station 300, based on the AI information of the target base station 300 and AI information of the UE 100 received from the source base station 200.

According to an embodiment of the disclosure, the first AI model determined in operation s1224 and the second AI model determined in operation s1245 may be AI models that correspond to each other in the same case. For example, in the case of CSI compression, the above-determined first AI model may be the AI model of the target base station 300 required for the UE 100 to perform CSI compression using the AI model of the UE 100, and the above-determined second AI model may be the AI model of the UE 100 required for the target base station 300 to restore CSI using the AI model of the target base station 300.

According to an embodiment of the disclosure, the UE 100 may determine the priority of AI model transfer, based on the AI information of the UE 100 and the AI information of the target base station 300. For example, in a case where there are a plurality of AI models to be transferred to the target base station 300, the UE 100 may determine the transfer priority of the plurality of AI models, and allow the source base station 200 to receive in the case of the AI model with high priority, and allow the target base station 300 to receive directly in the case of the AI model with a low priority. In a case where the source base station 200 receives the AI model from the UE 100, the source base station 200 may deliver the received AI model to the target base station 300. Here, latency sensitive information of case related to the corresponding AI model may be used to determine the priority of AI model transfer.

In operation s1248, the source base station 200 may receive AI model information scheduled to be transferred by the UE 100 from the UE 100. In this case, the UE 100 may transfer the UL AI model to the target base station 300 via the source base station 200, rather than directly transferring the UL AI model to the target base station 300.

Hereinafter, in a case where the UE 100 determines an AI model that performs UL transfer to the source base station 200, the AI model information may be information including the type of option for transferring or delivering the corresponding AI model, the priority of the AI model, scheduling information, or the like. Hereinafter, the AI model information may include at least one piece of the following information.
A name of an AI model scheduled to be transferred by the UE,
A size of an AI model scheduled to be transferred by the UE,
Use case requirements for an AI model scheduled to be transferred by the UE,
AI support case for an AI model scheduled to be transferred by the UE,
Case requiring update for an AI model scheduled to be transferred by the UE,
Vendor information about an AI model scheduled to be transferred by the UE, and
AI operation layer information of an AI model scheduled to be transferred by the UE

In operation s1251, the source base station 200 may perform scheduling for UL transfer of the AI model from the UE 100 to the source base station 200, based on the AI model information scheduled to be transferred by the UE 100 received from the UE 100.

According to an embodiment of the disclosure, the source base station 200 may determine an AI model transfer option and an AI model transfer priority, and perform scheduling for UL transfer of the AI model from the UE 100 to the source base station 200, based on the above-determined AI model transfer option and/or AI model transfer priority.

In operation s1254, the source base station 200 may transfer the AI model received from the target base station 300 to the UE 100 via a DL. The UE 100 may update the existing AI model of the UE 100 using the AI model received from the source base station 200.

In operation s1257, the source base station 200 may transfer an UL grant to the UE 100 by scheduling UL transfer of the determined AI model.

In operation s1260, the UE 100 may transfer the AI model to the source base station 200 based on the allocated UL grant.

In operation s1263, the source base station 200 may deliver the AI model received from the UE to the target base station 300. Thereafter, the target base station 300 may update the existing AI model of the target base station 300 with the received AI model.

Thereafter, in operation s1266, the remaining handover procedure may be performed.

According to an embodiment of the disclosure, the first AI model and second AI model may be used in a random access process. For example, the UE 100 may perform CSI compression using the first AI model and transfer the corresponding CSI report to the target base station 300. Additionally, the target base station 300 may decompress the CSI received from the UE 100 using the second AI model.

According to the above-described embodiments of the disclosure, by defining signaling between the UE and the network, efficient operation of the AI model transfer and delivery process between the UE and the network is possible. In addition, by defining signaling between the UE and the base station and the base station and the base station, the effect of enabling efficient operation of transfer and delivery of AI models within limited resources during handover can be provided.

Additionally, according to the above-described embodiments of the disclosure, by exchanging AI information prior to RA and determining the AI model to be transferred or delivered, transfer or delivery of the determined AI model immediately after RA may be possible, and thus, transfer or delivery of the AI model within a limited latency is possible. Alternatively, in the case of high priority, it may be possible to transfer the AI model in advance prior to the RA.

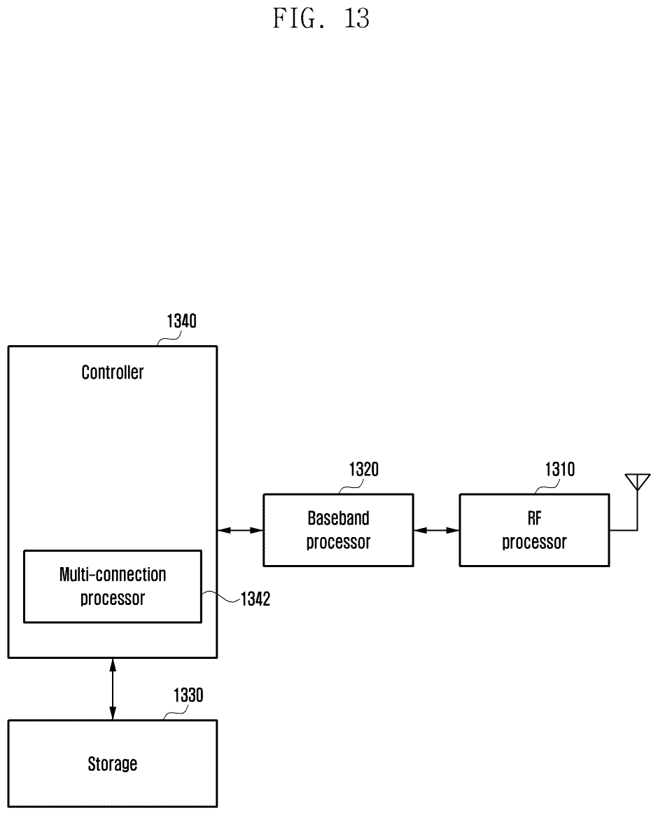

FIG. 13 is a block diagram illustrating a structure of a UE according to an embodiment of the disclosure.

Referring to FIG. 13, the UE includes a radio frequency (RF) processor 1310, a baseband processor 1320, a storage 1330, and a controller 1340.

The RF processor 1310 performs the functions of signal band conversion and amplification and the like to transmit and receive signals over a radio channel. The RF processor 1310 up-converts the baseband signal provided from the baseband processor 1320 into an RF band signal and then transmits the signal through the antenna, and down-converts the RF band signal received through the antenna into a baseband signal. For example, the RF processors 1310 may include a transmit filter, a receive filter, an amplifier, a mixer, an oscillator, a digital to analog convertor (DAC), an analog to digital convertor (ADC), and the like. Although one antenna is illustrated in the drawing, the UE may include a plurality of antennas. In addition, the RF processor 1310 may comprise a plurality of RF chains. Further, the RF processors 1310 may perform beamforming. For beamforming, the RF processor 1310 may adjust the phase and magnitude of each signals transmitted and received through a plurality of antennas or antenna elements. The RF processor may perform MIMO operation, and may receive multiple layers when performing the MIMO operation.

The baseband processor 1320 performs the function of converting between baseband signals and bit strings according to the physical layer protocol of the system. For example, the baseband processor 1320 performs coding and modulation on the transmission bit string to generate complex symbols when transmitting data. In addition, when receiving data, the baseband processor 1320 performs demodulation and decoding on the baseband signal provided from the RF processor 1310 to recover the received bit string. For example, in case of following an orthogonal frequency division multiplexing (OFDM) scheme, the baseband processor 1320 performs coding and modulation on the transmission bit string to generate complex symbols, maps the complex symbols to subcarriers, performs inverse fast Fourier transform (IFFT) computation on the subcarriers, and inserts cyclic prefix (CP) to generate OFDM symbols when transmitting data. In addition, when receiving data, the baseband processor 1320 separates the baseband signal provided from the RF processor 1310 into OFDM symbols, restores the signal mapped to the subcarriers by the fast Fourier transform (FFT) computation, and performs demodulation and decoding to restore the bit string.

As described above, the baseband processors 1320 and RF processors 1310 are responsible for transmitting and receiving signals. Accordingly, the baseband processors 1320 and RF processors 1310 may be referred to as a transmitter, a receiver, a transceiver, or a communicator. Further, at least one of the baseband processor 1320 and the RF processor 1310 may comprise a plurality of communication modules for supporting different radio access technologies. In addition, at least one of the baseband processor 1320 and the RF processor 1310 may include different communication modules for processing different frequency band signals. Examples of different radio access technologies include wireless local area networks (WLANs) (e.g., institute of electrical and electronics engineers (IEEE) 802.11), cellular networks (e.g., LTE), and the like. In addition, different frequency bands may include super high frequency (SHF) bands (e.g., 2.N RHz, N Rhz) and millimeter wave bands (e.g., 60 GHZ).

The storage 1330 stores basic programs for the operation of the UE, application programs, and data, such as configuration information. More particularly, the storage 1330 may store information about the secondary access node with which the UE performs radio communication using the secondary radio access technology. Further, the storage 1330 provides stored data in response to a request from the controller 1340. The controller 1340 may include a multi-connection processor 1342.

The controller 1340 controls the overall operation of the UE. For example, the controller 1340 transmits and receives signals through the baseband processor 1320 and RF processor 1310. The controller 1340 also writes data to the storage 1330 and reads data from the storage 1330. To achieve this, the controller 1340 may include at least one processor. For example, the controller 1340 may include communication processor (CP) for controlling communications and application processor (AP) for controlling upper layers, such as application programs.

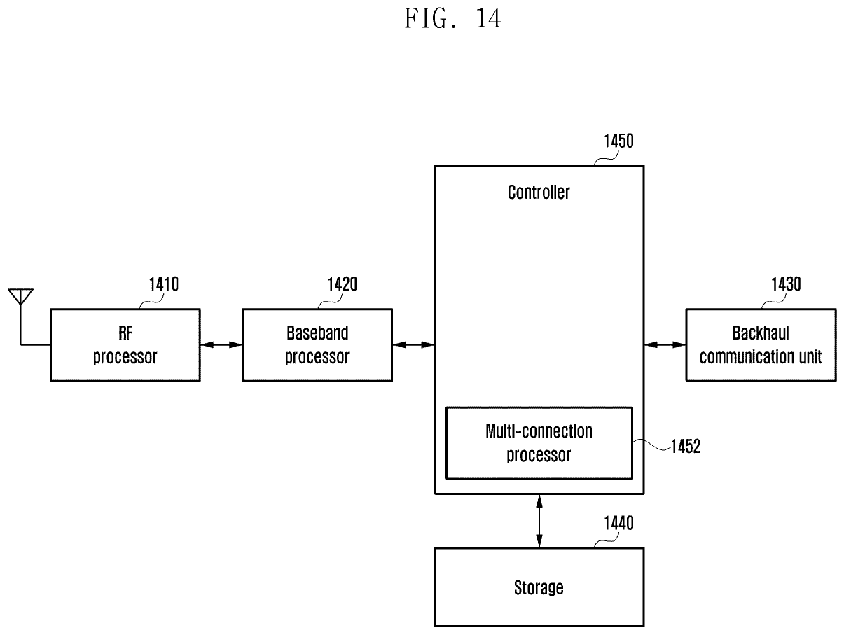

FIG. 14 is a block diagram illustrating a constitution of a NR base station according to an embodiment of the disclosure.

Referring to FIG. 14, the base station is constituted to include an RF processor 1410, a baseband processor 1420, a backhaul communicator 1430, a storage 1440, and a controller 1450.

The RF processor 1410 performs the function of signal band conversion, amplification and the like to transmit and receive signals over the radio channel. The RF processor 1410 up-converts the baseband signals provided from the baseband processor 1420 into RF band signals, and then transmits the signal through the antennas, and down-converts the RF band signals received through the antennas into baseband signals. For example, the RF processor 1410 may include a transmit filter, a receive filter, an amplifier, a mixer, an oscillator, a DAC, an ADC, and the like. Although one antenna is depicted in the drawing, the first access node may include a plurality of antennas. In addition, the RF processor 1410 may comprise a plurality of RF chains. The RF processor 1410 may perform beamforming. For beamforming, the RF processor 1410 may adjust the phase and magnitude of signals transmitted and received through a plurality of antennas or antenna elements. The RF processor 1410 may perform downlink MIMO operations to transfer signals on one or more layers.

The baseband processor 1420 performs the function of converting between baseband signals and bit strings according to the physical layer protocol of a first radio access technology. For example, the baseband processor 1420 performs coding and modulation on the transmission bit string to generate complex symbols when transmitting data. The baseband processor 1420 also performs demodulation and decoding on the baseband signals provided from the RF processor 1410 to recover the received bit string when receiving data. For example, in the case of following an OFDM scheme, the baseband processor 1420 performs coding and modulation on a transmission bit string to generate complex symbols, maps the complex symbols to subcarriers, performs IFFT computation on the subcarriers, and insert CP to generate OFDM symbols when transmitting data. In addition, the baseband processor 1420 separates the baseband signals provided from the RF processor 1410 into OFDM symbols, recovers the signals mapped to the subcarriers by the FFT computation, and performs demodulation and decoding to recover the receiving bit strings when receiving data. As described above, the baseband processor 1420 and RF processor 1410 are responsible for transmitting and receiving signals. Thus, the baseband processor 1420 and RF processor 1410 may be referred to as a transmitter, a receiver, a transceiver, a communicator, or a wireless communicator.

The backhaul communicator 1430 provides interfaces for communicating with other nodes in a network. The backhaul communicator 1430 converts a bit string to be transmitted from the main base station to another node, for example, an auxiliary base station, a core network, or the like into a physical signal, and converts a physical signal received from another node into a bit string.

The storage 1440 stores basic programs, application programs, and data, such as configuration information for the operation of the main base station. More particularly, the storage 1440 may store information about bearers allocated to the connected UE, measurement results reported by the connected UE, and the like. The storage 1440 may also store information as criteria for determining whether to enable or disable multi-connectivity of the UE. In addition, the storage 1440 provides stored data in response to requests from the controller 1450. The controller 1450 may include a multi-connection processor 1452.

The controller 1450 controls the overall operations of the base station. For example, the controller 1450 transmits and receives signals through the baseband processor 1420 and RF processor 1410, or through the backhaul communicator 1430. The controller 1450 also writes data to the storage 1440 and reads data from the storage 1440. To achieve this, the controller 1450 may include at least one processor.

In the case of lower layer triggered mobility (LTM), a network may deliver, to a UE in advance, pieces of configuration information needed for handover, and may indicate, to the UE, performing of handover via a physical layer or MAC control element (CE). In this instance, an operation that the UE performs may change depending on a unit based on which predetermined configuration information is to be delivered to the UE.

The methods according to the embodiments described in the claims or specification of the disclosure may be implemented by hardware, software, or a combination of hardware and software.

In case that the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to execute the methods described in the claims or specification of the disclosure.

The programs (software modules or software) may be stored in non-volatile memories including random access memory and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. Further, a plurality of such memories may be included in the electronic device.

In addition, the programs may be stored in an attachable storage device which may access the electronic device through communication networks, such as the Internet, intranet, local area network (LAN), a wide LAN (WLAN), and storage area network (SAN) or a combination thereof. Such a storage device may access the electronic device performing the embodiments of the disclosure via an external port. Further, a separate storage device on the communication network may access a device performing the embodiments of the disclosure.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Meanwhile, embodiments of the disclosure disclosed in this specification and drawings merely present specific examples in order to easily describe the technical contents of the disclosure and help the understanding of the disclosure, and they are not intended to limit the scope of the disclosure. For example, it will be apparent to those of ordinary skill in the art to which the disclosure pertains that other modifications based on the technical spirit of the disclosure may be implemented. Further, each of the above embodiments may be operated in combination with each other, as needed. For example, the base station and UE may be operated by combining parts of an embodiment and another embodiment of the disclosure with each other. For example, the base station and UE may be operated by combining parts of first and second embodiments of the disclosure with each other. Further, other modifications based on the technical idea of the embodiment may be implemented in several other systems, such as a frequency division duplex (FDD) LTE system, a time division duplex (TDD) LTE system, a 5G or NR system.

Meanwhile, in the drawings illustrating a method of the disclosure, the order of description does not necessarily correspond to the order of execution, and the precedence relationship may be changed or may be executed in parallel.

Alternatively, in the drawings illustrating the method of the disclosure, some components may be omitted and only some components may be included within a range that does not impair the essence of the disclosure.

Further, the method of the disclosure may be implemented in a combination of some or all of the contents included in each embodiment within a range that does not impair the essence of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory, such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first base station in a communication system, the method comprising:
receiving a measurement report from a terminal;
transferring, to a second base station, a handover request message including information for transferring an artificial intelligence (AI) model;
determining a first AI model for transferring the AI model of the terminal based on a response message for a handover request and AI information of the terminal previously received from the terminal, the handover request including response information to the information for transferring the AI model received from the second base station; and
transferring, to the terminal, the determined first AI model and a message for performing handover.

2. The method of claim 1, wherein the AI information of the terminal includes at least one of a name of the AI model of the terminal, a size of the AI model of the terminal, an AI support case of the terminal, a use case requirement for the AI of the terminal, a case requiring update for the AI model of the terminal, or vendor information of the terminal.

3. The method of claim 1, wherein the transferring, to the terminal, of the determined first AI model and the message for performing the handover includes:
receiving second AI model information for transferring the AI model of the second base station from the terminal;
scheduling transfer of the first AI model and the second AI model using the received second AI model information and the determined first AI model;
transferring, to the terminal, the first AI model; and
receiving the second AI model from the terminal, and delivering, to the second base station, the second AI model,
wherein transfer of the first AI model is scheduled by the first base station, and
wherein the information for transferring the AI model is for requesting the AI information of the second base station.

4. A method performed by a terminal in a communication system, the method comprising:
transferring, to a first base station, a measurement report; and
receiving a first artificial intelligence (AI) model and a message for performing handover from the first base station,
wherein the first AI model is an AI model determined for transferring an AI model of the terminal, based on AI information of the terminal and AI information of a second base station.

5. The method of claim 4,
wherein the message for performing the handover further includes AI information of the second base station and a receiver indicator for indicating a receiver of an AI model, and
wherein the method further comprises:
determining a second AI model for transferring an AI model of the second base station based on the AI information of the terminal and the AI information of the second base station,
transferring, to the first base station indicated as a first receiver of the second AI model by the receiver indicator, information of the determined second AI model,
receiving, from the first base station, an uplink (UL) grant including scheduling information of the second AI model, and
transferring, to the first base station indicated by the receiver indicator, the second AI model.

6. The method of claim 4,
wherein the message for performing the handover further includes AI information of the second base station and a receiver indicator for indicating a receiver of an AI model, and
wherein the method further comprises:
determining a second AI model for transferring an AI model of the second base station based on the AI information of the terminal and the AI information of the second base station,
transferring, to the second base station indicated as a receiver of the second AI model by the receiver indicator, information of the determined second AI model,
receiving, from the second base station, an UL grant including scheduling information of the second AI model, and
transferring, to the second base station indicated by the receiver indicator, the second AI model.

7. A method performed by a second base station in a communication system, the method comprising:
receiving, from a first base station, a handover request message including information for determining a first artificial intelligence (AI) model for transferring an AI model of a terminal; and
transferring, to the first base station, a response message to a handover request, the handover request including response information to information for determining the first AI model for transferring an AI model of the terminal,
wherein the first AI model is an AI model determined with AI information of the terminal and AI information of the second base station.

8. The method of claim 7,
wherein the handover request message further includes the AI information of the terminal and a transmitter indicator for indicating a transmitter of an AI model, and
wherein the method further comprises:
determining the first AI model based on the AI information of the terminal and the AI information of the second base station,
transferring, to the first base station indicated as a transmitter of the first AI model by the transmitter indicator, the determined first AI model;
scheduling transfer of the first AI model by the second base station indicated as the transmitter of the first AI model, and
transferring, to the terminal, the determined first AI model based on the scheduling.

9. The method of claim 7, further comprising:
transferring, to the first base station, the first AI model requested by the first base station for transferring the AI model of the terminal; and
receiving, from the first base station, the second AI model determined by the terminal based on the AI information of the terminal and the AI information of the second base station, for transferring the AI model of the second base station,
wherein the information for determining the first AI model for transferring the AI model of the terminal includes information for requesting the AI information of the second base station, and
wherein response information to the information for transferring the AI model includes the AI information of the second base station.

10. A first base station in a communication system, the first base station comprising:
a transceiver configured to transmit and receive a signal; and
a controller that controls to:
receive a measurement report from a terminal,
transfer, to a second base station, a handover request message including information for transferring an artificial intelligence (AI) model,
determine a first AI model for transferring the AI model of the terminal based on a response message for a handover request and AI information of the terminal previously received from the terminal, the handover request including response information to the information for transferring the AI model received from the second base station, and
transfer, to the terminal, the determined first AI model and a message for performing a handover.

11. The first base station of claim 10, wherein the AI information of the terminal includes at least one of a name of the AI model of the terminal, a size of the AI model of the terminal, an AI support case of the terminal, a use case requirement for the AI of the terminal, a case requiring update for the AI model of the terminal, or vendor information of the terminal.

12. The first base station of claim 10,
wherein transfer of the first AI model is scheduled by the first base station, and
wherein the information for transferring the AI model is for requesting the AI information of the second base station.

13. The first base station of claim 10, wherein the controller controls to:
receive, from the terminal, second AI model information for transferring the AI model of the second base station;
schedule transfer of the first AI model and the second AI model using the received second AI model information and the determined first AI model;
transfer, to the terminal, the first AI model;
receive the second AI model from the terminal; and
deliver, to the second base station, the second AI model.

14. A terminal in a communication system, the terminal comprising:
a transceiver configured to transmit and receive a signal; and
a controller that controls to:
transfer, to a first base station, a measurement report, and
receive, from the first base station, a first artificial intelligence (AI) model and a message for performing handover,
wherein the first AI model is an AI model determined for transferring an AI model of the terminal, based on AI information of the terminal and AI information of a second base station.

15. The terminal of claim 14,
wherein the message for performing the handover further includes AI information of the second base station and a receiver indicator for indicating a receiver of an AI model, and
wherein the controller controls to:
determine a second AI model for transferring an AI model of the second base station based on the AI information of the terminal and the AI information of the second base station,
transfer, to the first base station indicated as a first receiver of the second AI model by the receiver indicator, information of the determined second AI model,
receive, from the first base station, an uplink (UL) grant including scheduling information of the second AI model, and
transfer, to the first base station indicated by the receiver indicator, the second AI model.

16. The terminal of claim 14,
wherein the message for performing the handover further includes AI information of the second base station and a receiver indicator for indicating a receiver of an AI model, and
wherein the controller further controls to:
determine a second AI model for transferring an AI model of the second base station based on the AI information of the terminal and the AI information of the second base station,
transfer, to the second base station indicated as a receiver of the second AI model by the receiver indicator, information of the determined second AI model,
receive, from the second base station, an UL grant including scheduling information of the second AI model, and
transfer, to the second base station indicated by the receiver indicator, the second AI model.

17. A second base station in a communication system, the second base station comprising:
a transceiver configured to transmit and receive a signal; and
a controller that controls to:
receive, from a first base station, a handover request message including information for determining a first artificial intelligence (AI) model for transferring an AI model of a terminal, and
transfer, to the first base station, a response message to a handover request, the handover request including response information to information for determining the first AI model for transferring an AI model of the terminal,
wherein the first AI model is an AI model determined with AI information of the terminal and AI information of the second base station.

18. The second base station of claim 17,
wherein the handover request message further includes the AI information of the terminal and a transmitter indicator for indicating a transmitter of an AI model, and
wherein the controller controls to:
determine the first AI model based on the AI information of the terminal and the AI information of the second base station, and
transfer, to the first base station indicated as a transmitter of the first AI model by the transmitter indicator, the determined first AI model.

19. The second base station of claim 17,
wherein the handover request message further includes the AI information of the terminal and a transmitter indicator for indicating a transmitter of an AI model, and
wherein the controller controls to:
determine the first AI model based on the AI information of the terminal and the AI information of the second base station,
schedule transfer of the first AI model by the second base station indicated as the transmitter of the first AI model, and
transfer, to the terminal, the determined first AI model based on the scheduling.

20. The second base station of claim 17,
wherein the controller controls to:
transfer, to the first base station, the first AI model requested by the first base station for transferring the AI model of the terminal, and
receive, from the first base station, the second AI model determined by the terminal based on the AI information of the terminal and the AI information of the second base station, for transferring the AI model of the second base station,
wherein the information for determining the first AI model for transferring the AI model of the terminal includes a message for requesting the AI information of the second base station, and
wherein response information to the information for transferring the AI model includes the AI information of the second base station.
